(19) United States
(12) Patent Application Publication
(10) Pub. No.: US 2024/0388157 A1
(43) Pub. Date: Nov. 21, 2024

(54) COIL ASSEMBLY, ARMATURE, AND ROTATING ELECTRICAL MACHINE

(71) Applicant: DENSO CORPORATION, Kariya-city (JP)

(72) Inventors: Toshio YAMAMOTO, Kariya-city (JP); Yuji HAYASHI, Kariya-city (JP)

(73) Assignee: DENSO CORPORATION, Kariya-city (JP)

(21) Appl. No.: 18/785,292

(22) Filed: Jul. 26, 2024

Related U.S. Application Data
(63) Continuation of application No. PCT/JP2022/042453, filed on Nov. 15, 2022.

(30) Foreign Application Priority Data
Jan. 28, 2022 (JP) 2022-011872

(51) Int. Cl. H02K 3/28; H02K 3/32; H02K 3/46

(52) U.S. Cl. CPC H02K 3/28; H02K 3/32; H02K 3/46; H02K 2203/09

(57) ABSTRACT

A coil assembly includes a plurality of strip members which are rolled or wound in a circumferential direction of the coil assembly. The strip members have at least portions overlapping each other in a radial direction of the coil assembly and stacked on one another in the radial direction of the coil assembly. The strip members have a plurality of coils disposed thereon. The coil assembly also has a thin-walled portion and thick-walled portions. The thin-walled portion is defined by a portion of the strip members and has a first thickness in the radial direction. The thick-walled portions are defined by portions of the strip members and have a second thickness in the radial direction which is greater than the first thickness. The thick-walled portions are arranged away from each other in the circumferential direction.

### CROSS REFERENCE TO RELATED DOCUMENT

The present application claims the benefit of priority of Japanese Patent Application No. 2022-011872 filed on Jan. 28, 2022, the disclosure of which is incorporated in its entirety herein by reference.

### TECHNICAL FIELD

This disclosure relates generally to a coil assembly, an armature, and a rotating electrical machine.

### BACKGROUND ART

Patent literature, as listed below, teaches a coil assembly constituting a portion of an armature installed in a rotating electrical machine. The coil assembly includes a first conductive cylinder, a second conductive cylinder, and an electrical insulator disposed between the first and second conductive cylinders. The first conductive cylinder is equipped with a plurality of first conductive strips which extend in an axial direction of the first conductive cylinder and are arranged adjacent to and away from each other in a circumferential direction of the first conductive cylinder. Similarly, the second conductive cylinder is equipped with a plurality of second conductive strips which extend in an axial direction of the second conductive cylinder and are arranged adjacent to and away from each other in a circumferential direction of the second conductive cylinder. The electrical insulator works to electrically isolate between the first conductive strips and the second conductive strips. This structure enables the coil assembly to be designed to have a simple structure and produced at reduced costs without sacrificing electrical properties of the coil assembly.

### PRIOR ART DOCUMENT

### Patent Literature

PATENT LITERATURE: Japanese Patent First Publication No. 2017-070140

### SUMMARY OF THE INVENTION

It is preferable for a structure in which a coil assembly is arranged around the periphery of an armature core to minimize misalignment of the coil assembly with the armature core in a radial direction thereof.

It is an object of this disclosure to provide a coil assembly, an armature, and a rotating electrical machine which are designed to minimize misalignment of the coil assembly from an armature core in a radial direction thereof.

According to one aspect of this disclosure, there is provided a coil assembly which comprises: (a) a plurality of strip members which are made from an electrically insulating material, rolled in a circumferential direction of the coil assembly, and stacked on one another in a radial direction of the coil assembly, the strip members having at least portions overlapping each other in the radial direction of the coil assembly; (b) a plurality of coils which are made from an electrically conductive material and formed on the strip members, the coils being arranged in the circumferential direction; (c) thin-walled portions which are defined by portions of the strip members and have a first thickness in the radial direction; and (d) a plurality of thick-walled portions which are defined by portions of the strip members and have a second thickness in the radial direction which is greater than the first thickness. The thick-walled portions are arranged away from each other in the circumferential direction. An armature designed to solve the above problem includes an armature core which is made from a soft magnetic material into a hollow cylindrical shape and the above-described coil assembly disposed on one of a radial outer peripheral surface and a radial inner peripheral surface of the armature core. A rotating electrical machine designed to solve the above problem includes a first one of a stator and a rotor which includes the above-described armature and a second one of the stator and the rotor which has magnets arranged to face the coil assembly in the radial direction.

The above structure is capable of minimizing misalignment of the coil assembly from an armature core in a radial direction thereof.

### BRIEF DESCRIPTION OF THE DRAWINGS

The above-described object, other objects, features, or beneficial advantages in this disclosure will be apparent from the following detailed discussion with reference to the drawings.

In the drawings:

FIG. 1 is a longitudinal sectional view of an electrical motor, as taken along an axial direction thereof, in the first embodiment;

FIG. 2 is a transverse sectional view of an electrical motor, as taken in a radial direction thereof, in the first embodiment;

FIG. 3 is a perspective view which schematically illustrates a coil assembly;

FIG. 4A is a plan view which schematically illustrates a coil assembly equipped with rolled strip members;

FIG. 4B is a plan view which schematically illustrates a coil assembly and a stator core;

FIG. 5 is an explanatory view which illustrates a star-connection;

FIG. 6 is a view which illustrates connections of a plurality of coils;

FIG. 7 is a view which schematically illustrates a coil;

FIG. 8 is a schematic view which partially illustrates a first combination of U-phase coils which is axially offset from other combinations of U-phase coils;

FIG. 9 is a development view of a coil assembly;

FIG. 10 is a sectional view which partially illustrates a coil assembly;

FIG. 11 is a sectional view which partially illustrates a coil assembly;

FIG. 12 is a sectional view which partially illustrates a coil assembly;

FIG. 13 is a sectional view of a coil assembly, as taken in a radial direction thereof;

FIG. 14 is a sectional view which partially illustrates the coil assembly, as shown in FIG. 10, which is equipped with a second insulating layer;

FIG. 15 is a sectional view which partially illustrates the coil assembly, as shown in FIG. 11, which is equipped with a second insulating layer;

FIG. 16 is a sectional view which partially illustrates the coil assembly, as shown in FIG. 12, which is equipped with a second insulating layer;

FIG. 17 is a plan view which illustrates a coil assembly of an electrical motor according to the second embodiment;

FIG. 18 is a development view which illustrate the coil assembly in FIG. 17;

FIG. 19 is a schematic view which partially illustrates a first combination of U-phase coils which is axially offset from other combinations of U-phase coils;

FIG. 20 is a plan view which illustrates a coil assembly of an electrical motor according to the third embodiment;

FIG. 21 is a development view which illustrate the coil assembly in FIG. 20;

FIG. 22 is a schematic view which partially illustrates a first combination of U-phase coils which is axially offset from other combinations of U-phase coils;

FIG. 23 is a plan view which illustrates a coil assembly of an electrical motor according to the fourth embodiment;

FIG. 24 is a development view which illustrates the coil assembly in FIG. 23;

FIG. 25 is a schematic view which partially illustrates a first combination of U-phase coils which is axially offset from other combinations of U-phase coils;

FIG. 26 is a plan view which illustrates a coil assembly of an electrical motor according to the fifth embodiment;

FIG. 27 is a development view which illustrates the coil assembly in FIG. 26;

FIG. 28 is a schematic view which partially illustrates a first combination of U-phase coils which is axially offset from other combinations of U-phase coils;

FIG. 29 is a perspective view which illustrates a coil assembly of an electrical motor according to the sixth embodiment;

FIG. 30 is a development view which illustrates the coil assembly in FIG. 29;

FIG. 31 is a plan view which illustrates a coil assembly and a stator core of an electrical motor according to the seventh embodiment;

FIG. 32 is a plan view which illustrates a coil assembly and a stator core of an electrical motor according to the eighth embodiment;

FIG. 33 is a plan view which illustrates a coil assembly of an electrical motor;

FIG. 34 is a plan view which illustrates a coil assembly and an insulator installed in an electrical motor according to the ninth embodiment;

FIG. 35 is a plan view which illustrates a coil assembly and an insulator installed in an electrical motor according to the tenth embodiment;

FIG. 36 is a plan view which illustrates a coil assembly and an insulator installed in an electrical motor according to the eleventh embodiment;

FIG. 37 is a development view which illustrates a coil assembly of an electrical motor according to the twelfth embodiment; and

FIG. 38 is a plan view which illustrates the coil assembly in FIG. 37.

### MODE FOR CARRYING OUT THE INVENTION

### First Embodiment

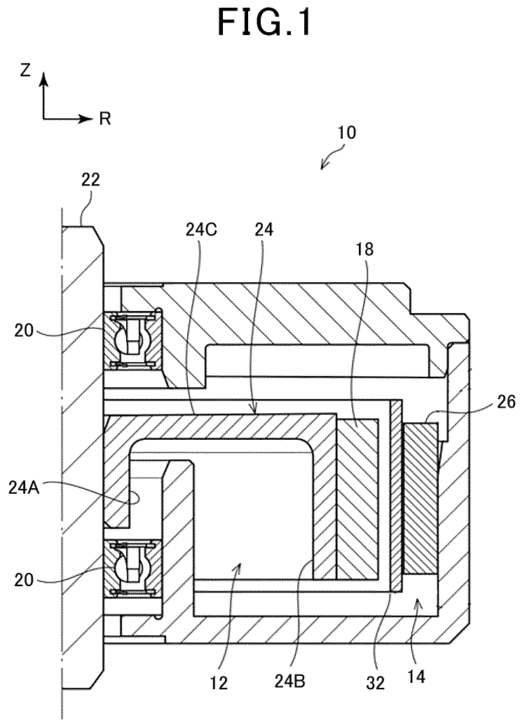

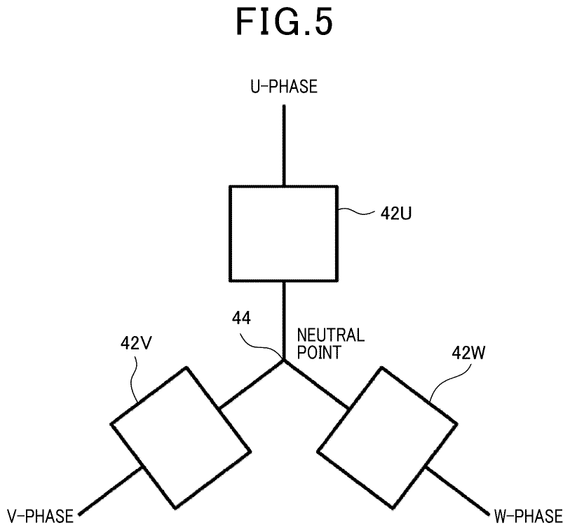

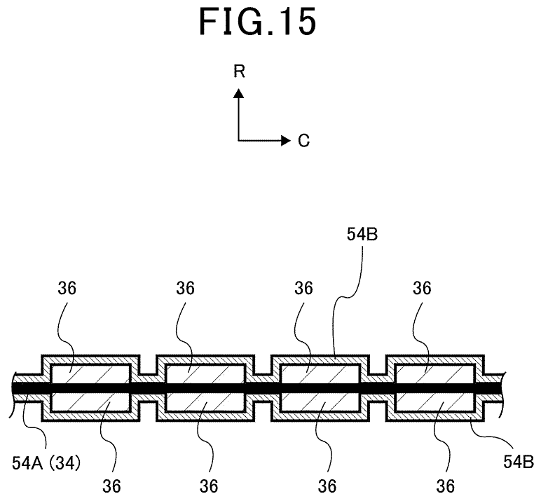

The electrical motor 10 according to the first embodiment in this disclosure will be described below with reference to FIGS. 1 to 16. In the drawings, directions expressed by arrows Z, R, and C correspond to a first direction that is a direction of rotation of an axis of the rotor 12, an outward radial direction of the rotor 12, and a first circumferential direction oriented along a circumference of the rotor 12, respectively. An axial direction, a radial direction, and a circumferential direction which are simply referred to in the following discussion correspond to an axial direction, a radial direction, and a circumferential direction of the rotor 12 unless otherwise specified. The motor 10, as referred to in this disclosure, is an example of a rotating electrical machine.

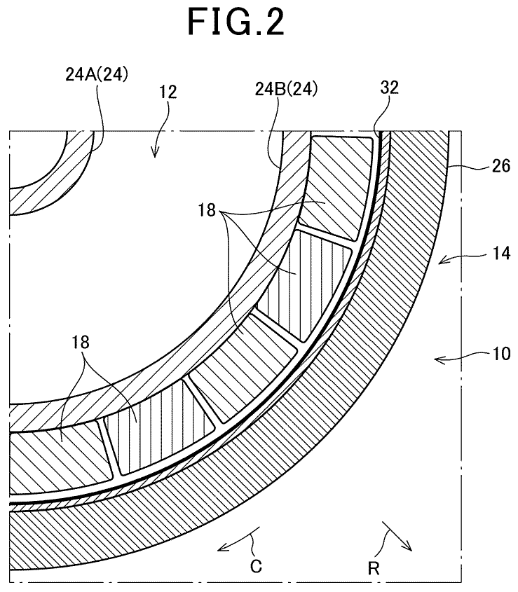

The motor 10 is, as illustrated in FIGS. 1 and 2, designed as an inner-rotor brushless motor which has the rotor 12 arranged radially inside the stator 14 serving as an armature. FIGS. 1 and 2 schematically show the motor 10 for the sake of simplicity of illustration, therefore, the number of the coils 16 or magnets 18 or a detailed configuration of the motor 10 may be different from those discussed later.

The rotor 12 includes the rotating shaft 22, the rotor core 24, and the magnets 28. The rotating shaft 22 is retained by a pair of bearings 20 to be rotatable. The rotor core 24 is of a hollow cylindrical shape with a bottom and secured to the rotating shaft 22. The magnets 28 are fixed on a radial outer periphery of the rotor core 24.

The rotor core 24 includes the first cylinder 24A, the second cylinder 24B, and the connecting plate 24C. The first cylinder 24A is of a hollow cylindrical shape and has the rotating shaft 22 press-fit therein. The second cylinder 24B is of a hollow cylindrical shape and arranged radially outside the first cylinder 24A. The connecting plate 24C is of a disc shape and connects between axial ends of the first cylinder 24A and the second cylinder 24B. The second cylinder 24B has a radial outer periphery which is of a cylindrical shape and extends in the circumferential direction. The magnets 18 are secured to the outer periphery of the second cylinder 24B.

The magnets 18 are made from a magnetic compound which has an intrinsic coercive force Hc of 400 kA/m or more and a remanent flux density Br of 1.0T or more. For instance, each of the magnets 18 is made from a magnetic compound of NdFe₁₁TiN, Nd₂Fe₁₄B, Sm₂Fe₁₇N₃, or FeNi. The magnets 18 are firmly mounted on the outer periphery of the second cylinder 24B of the rotor core 24. The magnets 18 are broken down into first magnets 18 and second magnets 18. Each of the first magnets 18 has an N-pole on a radial outer surface thereof. Each of the second magnets 18 has an S-pole on a radial outer surface thereof. The first and second magnets 18 are arranged alternately adjacent to each other in the circumferential direction. The number of the magnets 18 depends upon the degree of output power required for the motor 10.

The stator 14 includes the hollow cylindrical stator core 26 serving as an armature core and the coil assembly 32 secured to the stator core 26. The stator 14 is, as can be seen in FIGS. 1 to 4B, of a tooth-less structure in which a portion of the stator core 26 is not arranged inside the coils 16 of the coil assembly 32.

The stator core 26 is, as illustrated in FIGS. 1 and 2, of an annular or hollow cylindrical shape and made from a soft magnetic material, such as steel. The stator core 26 is arranged coaxially with the rotor 12. In other words, the stator core 26 is located to have a center axis aligned with that of an assembly of the magnets 18 fixed to the rotor core 24 in the axial direction of the rotor 12.

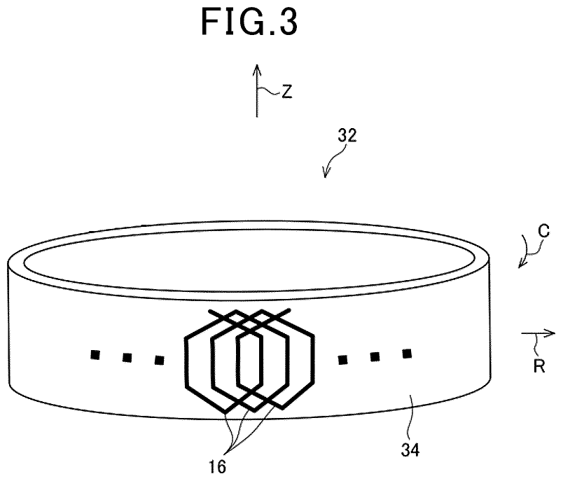

The coil assembly 32, as illustrated in FIG. 3, includes a plurality of strip members 34 and the coils 16. Each of the strip members 34 is of a circular-shape and made from an electrically insulating material. The coils 16 are made from an electrically conductive material and formed on the strip members 34.

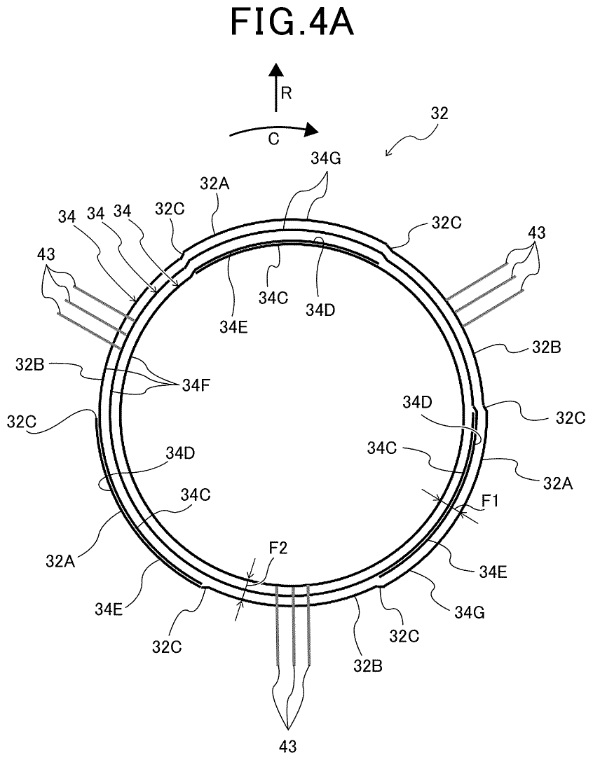

When spread into a planar shape, each of the strip members 34 has a width in the axial direction of the rotor 12 and a length in a direction perpendicular to the axial direction. Each of the strip members 34 has a thickness small enough to be bent or curled in the circumferential direction of the rotor 12. The coil assembly 32, as can be seen in FIG. 4A, includes the strip members 34 each curved or rolled into a closed circular shape. Specifically, the coil assembly 32 has the three strip members 34 which are different in outer and inner diameters from each other. One of the strip members 34 is located radially inside the other, thereby completing a three-layer structure of the coil assembly 32 made of a stack of the strip members 34. In the following discussion, a radially innermost one of the strip members 34 will also be referred to as a first strip member 34, a radially outermost one of the strip members 34 will also be referred to as a third strip member 34, and one of the strip members 34 which is arranged between the first and third strip members 34 will also be referred to as a second strip member 34.

The coils 16 are, as clearly illustrated in FIG. 3, formed on the strip members 34. The first and second strip members 34 are, as can be seen in FIGS. 3 and 4A, arranged radially inside the second and third strip members 34, respectively, so that the coils 16 are located at preselected positions both in the circumferential direction and in the radial direction.

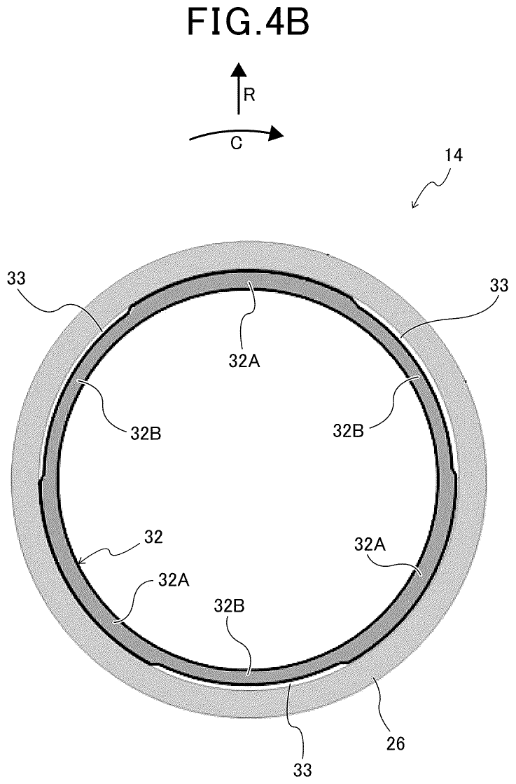

The coils 16 is, as illustrated in FIG. 5, broken down into three groups: the U-phase coil group 42U creating a U-phase, the V-phase coil group 42V creating a V-phase, and the W-phase coil group 42W creating a W-phase. The U-phase coil group 42U, the V-phase coil group 42V, and the W-phase coil group 42W are star-connected together. The U-phase coil group 42U includes the eighteen coils 16. The V-phase coil group 42V includes the eighteen coils 16. Similarly, the W-phase coil group 42W includes the eighteen coils 16.

In the following discussion, the eighteen coils 16 of the U-phase coil group 42U will also be referred to below as coils U11, U12, U13, U21, U22, U23, U31, U32, U33, U41, U42, U43, U51, U52, U53, U61, U62, and U63.

Similarly, the eighteen coils 16 of the V-phase coil group 42V will also be referred to below as coils V11, V12, V13, V21, V22, V23, V31, V32, V33, V41, V42, V43, V51, V52, V53, V61, V62, and V63.

Similarly, the eighteen coils 16 of the W-phase coil group 42W will also be referred to below as coils W11, W12, W13, W21, W22, W23, W31, W32, W33, W41, W42, W43, W51, W52, W53, W61, W62, and W63.

In the following discussion, a specified one(s) of the coils 16 will be denoted only using the above coil reference number(s).

The coils U11, U12, and U13 are connected in series with each other. The coils U21, U22, and U23 are connected in series with each other. The coils U31, U32, and U33 are connected in series with each other. The coils U41, U42, and U43 are connected in series with each other. The coils U51, U52, and U53 are connected in series with each other. The coils U61, U62, and U63 are connected in series with each other.

The coil U13 has a first end and a second end with the first end connecting with the coil U12. The coil U23 has a first end and a second end with the first end connecting with the coil U22. The coil U33 has a first end and a second end with the first end connecting with the coil U32. The coil U43 has a first end and a second end with the first end connecting with the coil U42. The coil U53 has a first end and a second end with the first end connecting with the coil U52. The coil U63 has a first end and a second end with the first end connecting with the coil U62. The second ends of the coils U13, U23, U33, U43, U53, and U63 are connected together.

The coils V11, V12, and V13 are connected in series with each other. The coils V21, V22, and V23 are connected in series with each other. The coils V31, V32, and V33 are connected in series with each other. The coils V41, V42, and V43 are connected in series with each other. The coils V51, V52, and V53 are connected in series with each other. The coils V61, V62, and V63 are connected in series with each other.

The coil V13 has a first end and a second end with the first end connecting with the coil V12. The coil V23 has a first end and a second end with the first end connecting with the coil V22. The coil V33 has a first end and a second end with the first end connecting with the coil V32. The coil V43 has a first end and a second end with the first end connecting with the coil V42. The coil V53 has a first end and a second end with the first end connecting with the coil V52. The coil V63 has a first end and a second end with the first end connecting with the coil V62. The second ends of the coils V13, V23, V33, V43, V53, and V63 are connected together.

The coils W11, W12, and W13 are connected in series with each other. The coils W21, W22, and W23 are connected in series with each other. The coils W31, W32, and W33 are connected in series with each other. The coils W41, W42, and W43 are connected in series with each other. The coils W51, W52, and W53 are connected in series with each other. The coils W61, W62, and W63 are connected in series with each other.

The coil W13 has a first end and a second end with the first end connecting with the coil W12. The coil W23 has a first end and a second end with the first end connecting with the coil W22. The coil W33 has a first end and a second end with the first end connecting with the coil W32. The coil W43 has a first end and a second end with the first end connecting with the coil W42. The coil W53 has a first end and a second end with the first end connecting with the coil W52. The coil W63 has a first end and a second end with the first end connecting with the coil W62. The second ends of the coils W13, W23, W33, W43, W53, and W63 are connected together.

The coil U11 has a first end and a second end connecting with the coil U12. The coil V11 has a first end and a second end connecting with the coil V12. The coil W11 has a first end and a second end connecting with the coil W12. The first ends of the coils U11, V11, and W11 are connected together.

The coil U21 has a first end and a second end connecting with the coil U22. The coil V21 has a first end and a second end connecting with the coil V22. The coil W21 has a first end and a second end connecting with the coil W22. The first ends of the coils U21, V21, and W21 are connected together.

The coil U31 has a first end and a second end connecting with the coil U32. The coil V31 has a first end and a second end connecting with the coil V32. The coil W31 has a first end and a second end connecting with the coil W32. The first ends of the coils U31, V31, and W31 are connected together.

The coil U41 has a first end and a second end connecting with the coil U42. The coil V41 has a first end and a second end connecting with the coil V42. The coil W41 has a first end and a second end connecting with the coil W42. The first ends of the coils U41, V41, and W41 are connected together.

The coil U51 has a first end and a second end connecting with the coil U52. The coil V51 has a first end and a second end connecting with the coil V52. The coil W51 has a first end and a second end connecting with the coil W52. The first ends of the coils U51, V51, and W51 are connected together.

The coil U61 has a first end and a second end connecting with the coil U62. The coil V61 has a first end and a second end connecting with the coil V62. The coil W61 has a first end and a second end connecting with the coil W62. The first ends of the coils U61, V61, and W61 are connected together.

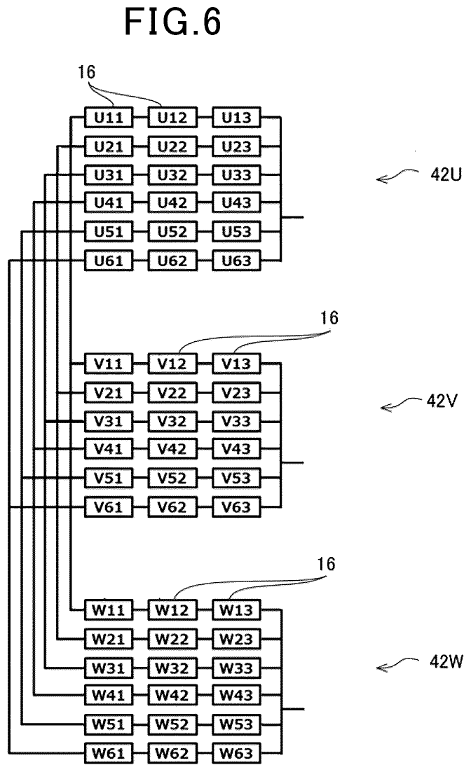

FIG. 7 schematically illustrates the U-phase coils 16. When viewed in the thickness direction of the strip members 24, each of the coils 16 is of a hexagonal shape and made of three turns of a conductor.

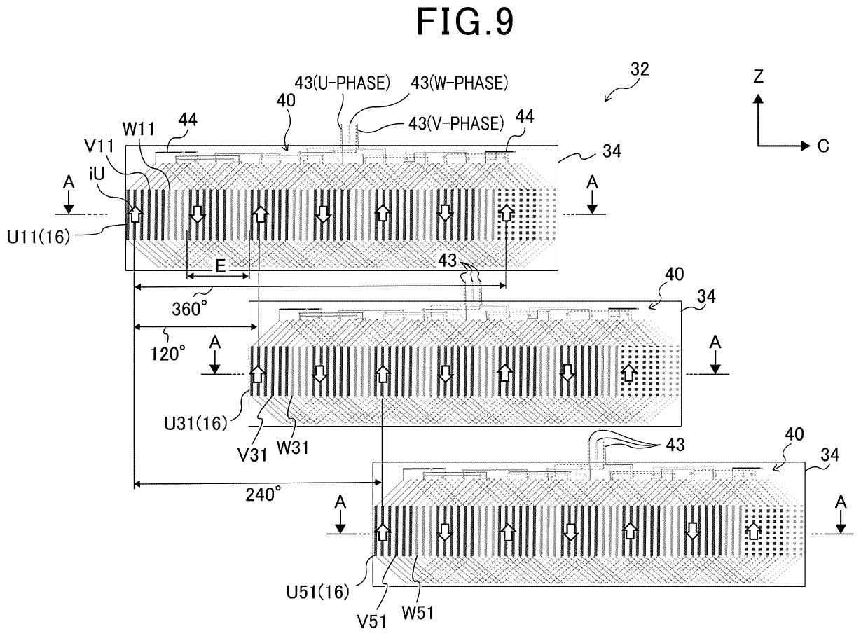

The coil U11 has a first, a second, and a third turn. The first turn of the coil U11 includes the first straight section A1, the second straight section A2, the third straight section A3, the fourth straight section A4, the fifth straight section A5, and the sixth straight section A6. In the following discussion, an upper direction, as viewed in the FIG. 7, of the strip members 34 (i.e., the rotor 12) will also be referred to as a first axial direction, while a lower direction will also be referred to as a second axial direction. A rightward direction, as viewed in FIG. 7, will also be referred to as a first circumferential direction, while a leftward direction will also be referred to as a second circumferential direction. The first straight section A1 extends obliquely in the second axial direction and slants in the second circumferential direction. The second straight section A2 continuing from the first straight section A1 extends straight in the second axial direction. The third straight section A3 continuing from the second straight section A2 extends obliquely in the second axial direction and slants in the first circumferential direction. The fourth straight section A4 extends obliquely from the third straight section A3 in the first axial direction and slants in the first circumferential direction. The fifth straight section A5 extends straight from the fourth straight section A4 in the first axial direction. The sixth straight section A6 continuing from the fifth straight section A5 extends obliquely in the first axial direction and slants in the second circumferential direction. The first straight section A1, the second straight section A2, and the third straight section A3 are formed on the first surface 34A (see FIG. 10) of a corresponding one of the strip members 34. The straight section A4, the fifth straight section A5, and the sixth straight section A6 are formed on the second surface 34B of the corresponding strip member 34. The third straight section A3 and the fourth straight section A4 are electrically connected together through a via hole (i.e., through hole) formed in the strip member 34. The first, second, and third straight sections A1, A2, and A3 formed on the first surface 34A of the strip member 34 are expressed by solid lines, while the fourth, fifth, and sixth straight sections A4, A5, and A6 formed on the second surface 34B of the strip member 34 are expressed by broken lines.

The second turn of the coil U11 includes the first straight section B1, the second straight section B2, the third straight section B3, the fourth straight section B4, the fifth straight section B5, and the sixth straight section B6. The first straight section B1 continues from the sixth straight section A6 of the first turn, extends obliquely in the second axial direction, and slants in the second circumferential direction. The second straight section B2 continuing from the first straight section B1 extends straight in the second axial direction. The third straight section B3 continuing from the second straight section B2 extends obliquely in the second axial direction and slants in the first circumferential direction. The fourth straight section B4 extends obliquely from the third straight section B3 in the first axial direction and slants in the first circumferential direction. The fifth straight section B5 extends straight from the fourth straight section B4 in the first axial direction. The sixth straight section B6 continuing from the fifth straight section B5 extends obliquely in the first axial direction and slants in the second circumferential direction. The sixth straight section A6 and the first straight section B1 are electrically connected together through a via hole (i.e., through hole) passing through the strip member 34. The third straight section B3 and the fourth straight section B4 are electrically connected together through a via hole passing through the strip member 34.

The third turn of the coil U11 includes the first straight section C1, the second straight section C2, the third straight section C3, the fourth straight section C4, the fifth straight section C5, and the sixth straight section C6. The first straight section C1 continues from the sixth straight section B6 of the second turn, extends obliquely in the second axial direction, and slants in the second circumferential direction. The second straight section C2 continuing from the first straight section C1 extends straight in the second axial direction. The third straight section C3 continuing from the second straight section C2 extends obliquely in the second axial direction and slants in the first circumferential direction. The fourth straight section C4 extends obliquely from the third straight section C3 in the first axial direction and slants in the first circumferential direction. The fifth straight section C5 extends straight from the fourth straight section C4 in the first axial direction. The sixth straight section C6 continuing from the fifth straight section C5 extends obliquely in the first axial direction and slants in the second circumferential direction. The sixth straight section B6 and the first straight section C1 are electrically connected together through a via hole (i.e., through hole) passing through the strip member 34. The third straight section C3 and the fourth straight section C4 are electrically connected together through a via hole passing through the strip member 34.

The second turn (i.e., the first straight section B1 to the sixth straight section B6) of the coil U11 is offset from the first turn (i.e., the first straight section A1 to the sixth straight section A6) of the coil U11 in the first circumferential direction. Similarly, the third turn (i.e., the first straight section C1 to the sixth straight section C6) is offset from the second turn (i.e., the first straight section B1 to the sixth straight section B6) of the coil U11 in the first circumferential direction.

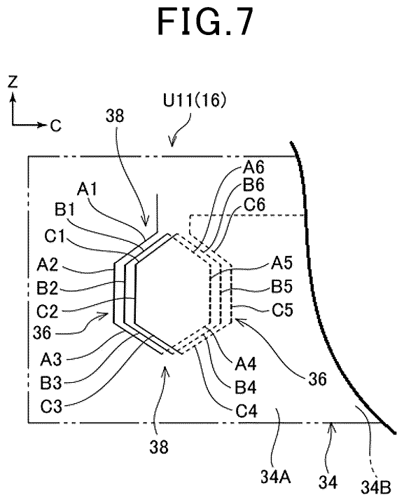

The U-phase coils U12 to U63 are, as can be seen in FIGS. 7 and 8, shaped to have the same structures as that of the coil U11. In other words, all the U-phase coils U11 to U63 are of the same structure. The second straight sections A2, B2, and C2 and the fifth straight sections A5, B5, and C5 will also be referred to as vertical sections 36. The first straight sections A1, B1, and C1 and the sixth straight sections A6, B6, and C6 will also be referred to as the first coil ends 38, while the third straight sections A3, B3, and C3 and the fourth straight sections A4, B4, and C4 will also be referred to as the second coil ends 38.

FIG. 8 schematically illustrates the coil U11 and the coil U12 which are parts of the U-phase coils as being offset in the axial direction.

The fifth straight section A5, the fifth straight section B5, and the fifth straight section C5 of the coil U11 are, as illustrated in FIGS. 7 and 8, located at the same positions as those of the second straight section A2, the second straight section B2, and the second straight section C2 of the coil U12 in the circumferential direction, respectively. In other words, the fifth straight section A5, the fifth straight section B5, and the fifth straight section C5 of the coil U11 overlap with the second straight section A2, the second straight section B2, and the second straight section C2 of the coil U12 through the strip member 34, respectively.

The fifth straight section A5, the fifth straight section B5, and the fifth straight section C5 of the coil U12 are arranged at the same positions as those of the second straight section A2, the second straight section B2, and the second straight section C2 of the coil U13 in the circumferential direction, respectively. In other words, the fifth straight section A5, the fifth straight section B5, and the fifth straight section C5 of the coil U12 overlap with the second straight section A2, the second straight section B2, and the second straight section C2 of the coil U13 through the strip member 34, respectively.

The fifth straight section A5, the fifth straight section B5, and the fifth straight section C5 of the coil U13 are arranged at the same positions as those of the second straight section A2, the second straight section B2, and the second straight section C2 of the coil U23 in the circumferential direction, respectively. In other words, the fifth straight section A5, the fifth straight section B5, and the fifth straight section C5 of the coil U13 overlap with the second straight section A2, the second straight section B2, and the second straight section C2 of the coil U23 through the strip member 34, respectively.

The fifth straight section A5, the fifth straight section B5, and the fifth straight section C5 of the coil U23 are arranged at the same positions as those of the second straight section A2, the second straight section B2, and the second straight section C2 of the coil U22 in the circumferential direction, respectively. In other words, the fifth straight section A5, the fifth straight section B5, and the fifth straight section C5 of the coil U23 overlap with the second straight section A2, the second straight section B2, and the second straight section C2 of the coil U22 through the strip member 34, respectively.

The fifth straight section A5, the fifth straight section B5, and the fifth straight section C5 of the coil U22 are arranged at the same positions as those of the second straight section A2, the second straight section B2, and the second straight section C2 of the coil U21 in the circumferential direction, respectively. In other words, the fifth straight section A5, the fifth straight section B5, and the fifth straight section C5 of the coil U22 overlap with the second straight section A2, the second straight section B2, and the second straight section C2 of the coil U21 through the strip member 34, respectively.

As apparent from the above discussion, the coils U11, U12, U13, U23, U22, and U21 are mounted adjacent each other in this order on the first strip member 34.

The sixth straight section C6 of the coil U11 connects with the sixth straight section C6 of the coil U12. The first straight section A1 of the coil U12 connects with the first straight section A1 of the coil U13. The sixth straight section C6 of the coil U23 connects with the sixth straight section C6 of the coil U22. The first straight section A1 of the coil U22 connects with the first straight section A1 of the coil U21. This layout causes the coils U11, U12, U13, U23, U22, and U21 to physically form a coil (i.e., a left-handed coil described later in detail) made by winding a conductor in one direction, but however, when electrically energized, the coils U11, U12, U13, U23, U22, and U21 play a role as a coil (i.e., a right-handed coil) in which the coils U11, U13, and U21 are wound in a direction opposite that in which the coils U12, U23, and U21 are wound. In the following discussion, for the sake of convenience, each of the coils U12, U23, and U21 will also be referred to as a left-handed coil, while each of the coils U11, U13, and U22 will also be referred to as a right-handed coil. In FIG. 8, overlines are drawn immediately above the reference symbols denoting the right-handed coils U11, U13, and U22. In this embodiments, the left-handed coils and the right-handed coils are arranged alternately in the circumferential direction. In the following embodiments, overlines are sometimes drawn above the reference symbols U, V, and W representing the phases of the coils 16.

Similar to the above, the fifth straight section A5, the fifth straight section B5, and the fifth straight section C5 of the coil U31 are arranged at the same positions as those of the second straight section A2, the second straight section B2, and the second straight section C2 of the coil U32 in the circumferential direction, respectively.

The fifth straight section A5, the fifth straight section B5, and the fifth straight section C5 of the coil U32 are arranged at the same positions as those of the second straight section A2, the second straight section B2, and the second straight section C2 of the coil U33 in the circumferential direction, respectively. In other words, the fifth straight section A5, the fifth straight section B5, and the fifth straight section C5 of the coil U32 are located to overlap with the second straight section A2, the second straight section B2, and the second straight section C2 of the coil U33 through the strip member 34, respectively.

The fifth straight section A5, the fifth straight section B5, and the fifth straight section C5 of the coil U33 are arranged at the same positions as those of the second straight section A2, the second straight section B2, and the second straight section C2 of the coil U43 in the circumferential direction, respectively. In other words, the fifth straight section A5, the fifth straight section B5, and the fifth straight section C5 of the coil U33 are located to overlap with the second straight section A2, the second straight section B2, and the second straight section C2 of the coil U43 through the strip member 34, respectively.

The fifth straight section A5, the fifth straight section B5, and the fifth straight section C5 of the coil U43 are arranged at the same positions as those of the second straight section A2, the second straight section B2, and the second straight section C2 of the coil U42 in the circumferential direction, respectively. In other words, the fifth straight section A5, the fifth straight section B5, and the fifth straight section C5 of the coil U43 are located to overlap with the second straight section A2, the second straight section B2, and the second straight section C2 of the coil U42 through the strip member 34, respectively.

The fifth straight section A5, the fifth straight section B5, and the fifth straight section C5 of the coil U42 are arranged at the same positions as those of the second straight section A2, the second straight section B2, and the second straight section C2 of the coil U41 in the circumferential direction, respectively. In other words, the fifth straight section A5, the fifth straight section B5, and the fifth straight section C5 of the coil U42 are located to overlap with the second straight section A2, the second straight section B2, and the second straight section C2 of the coil U41 through the strip member 34, respectively.

As apparent from the above discussion, the coils U31, U32, U33, U43, U42, and U41 are arranged adjacent each other in this order on the second strip member 34. The fifth straight section A5, the fifth straight section B5, and the fifth straight section C5 of the coil U21 on the first strip member 34 are arranged on the same positions as those of the second straight section A2, the second straight section B2, and the second straight section C2 of the coil U31 on the second strip member 34 in the circumferential direction.

The coils U31, U32, U33, U43, U42, and U41 mounted on the second strip member 34 are connected together in the same ways as those in which the coils U11, U12, U13, U23, U22, and U21 mounted on the first strip member 34 are connected together/

The coils U51 to U63 are arranged on the third strip member 34 in the same ways as those in which the coils U11 to U43 are arranged on the first and second strip members 34. The coils U51, U52, U53, U63, U62, and U61 are, therefore, located in this order on the third strip member 34. The fifth straight section A5, the fifth straight section B5, and the fifth straight section C5 of the coil U41 mounted on the second strip member 34 are arranged at the same positions as those of the second straight section A2, the second straight section B2, and the second straight section C2 of the coil U51 mounted on the third strip member 34 in the circumferential direction, respectively.

The coils U51, U52, U53, U63, U62, and U61 mounted on the third strip member 34 are connected together in the same ways as those in which the coils U11, U12, U13, U23, U22, and U21 mounted on the first strip member 34 are connected together.

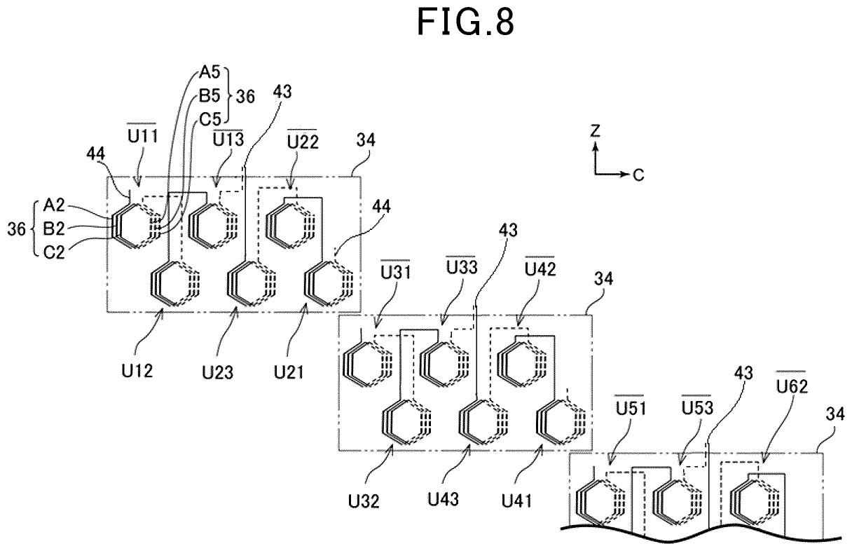

The V-phase coils V11 to V63 are, as can be seen in FIGS. 8 and 9, arranged on the first strip member 34, the second strip member 34, and the third strip member 34 in the same layouts as those in which the U-phase coils U11 to U63 arranged on the first strip member 34, the second strip member 34, and the third strip member 34. Similarly, the W-phase coils W11 to W63 are arranged on the first strip member 34, the second strip member 34, and the third strip member 34 in the same layouts as those in which the U-phase coils U11 to U63 arranged on the first strip member 34, the second strip member 34, and the third strip member 34. In contrast, the V-phase coils V11 to V63 are connected together in a way in which the winding direction of the V-phase coils V11 to V63 is opposite those of the U-phase coils U11 to U63 and the W-phase coils W11 to W63.

The V-phase coils V11 to V63 are offset from the U-phase coils U11 to U63 in the first circumferential direction. The W-phase coils W11 to W63 are offset from the V-phase coils V11 to V63 in the first circumferential direction.

FIG. 10 is a sectional view, as taken along the line A-A in FIG. 9, which partially illustrates the first strip member 34 and the coils 16. Specifically, FIG. 10 schematically shows an end of the first strip member 34 which faces in the second circumferential direction. The coils U11T1, U11T2, U11T3, V11T3, V11T2, V11T1, W11T1, W11T2, and W11T3 are, as clearly illustrated in FIG. 10, formed in this order on the first surface 34A of the first strip members 34. Note that “T1”, “T2”, or “T3” affixed to the reference symbol for each coil represents a number of each turn. Specifically, “T1” represents the first turn. “T2” represents the second turn. “T3” represents the third turn. For instance, “U11T1” indicates the first turn of the coil U11. “U11T2” indicates the second turn of the coil U11. “U11T3” indicates the third turn of the coil U11.

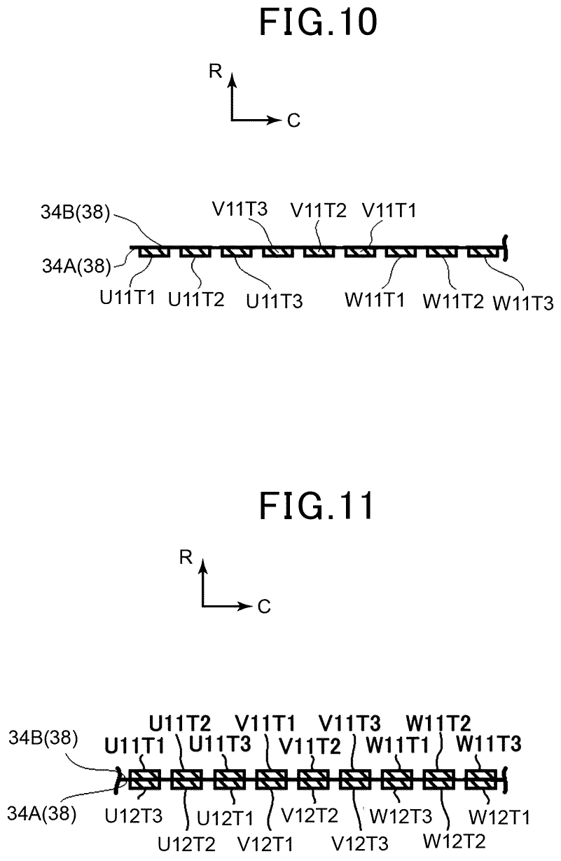

FIG. 11 is a sectional view, as taken along the line A-A in FIG. 9, which partially illustrates the first strip member 34 and the coils 16. The cross-section illustrated in FIG. 11 corresponds to a region of the first strip member 34 indicated by the arrow E in FIG. 9. The cross section in FIG. 11 is a portion of the first strip member 34 which is arranged adjacent to that illustrated in FIG. 10 in the circumferential direction. FIG. 11 shows the coils U12T3, U12T2, U12T1, V12T1, V12T2, V12T3, W12T3, W21T2, and W12T1 as being formed on the first surface 34A of the strip member 34 in this order and also shows the coils U11T1, U11T2, U11T3, V11T3, V11T2, V11T1, W11T1, W11T2, and W11T3 as being formed on the second surface 34B of the strip member 34 in this order.

Although not illustrated, the U-phase coils U12, U13, U23, U22, and U21, the V-phase coils V12, V13, V23, V22, and V21, and the W-phase coils W12, W13, W23, W22, and W21 are formed on the first and second surfaces 34A and 34B of the cross-section of the strip member 34 in FIG. 11 in the same layout as illustrated in FIG. 11.

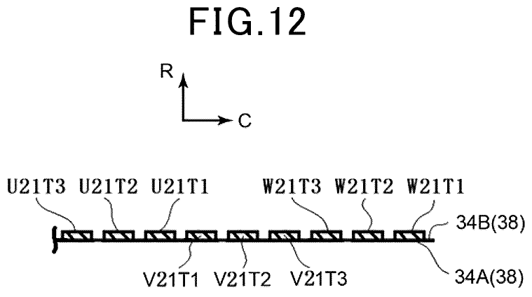

FIG. 12 is a sectional view, as taken along the line A-A in FIG. 9, which partially illustrates the first strip member 34 and the coils 16. The cross-section illustrated in FIG. 12 corresponds to an end portion of the first strip member 34 facing the first circumferential direction. The coils U21T1, U21T2, U21T3, V21T3, V21T2, V21T1, W21T1, W21T2, and W21T3 are formed on the second surface 34B of the strip member 34 in this order.

Although not illustrated, the U-phase coils U31 to U41, the V-phase coils V31 to V41, and the W-phase coils W31 to W41 are formed on the first and second surfaces 34A and 34B of the strip member 34 in the same layout as illustrated in FIGS. 10 to 12. Similarly, the U-phase coils U51 to U61, the V-phase coils V51 to V61, and the W-phase coils W51 to W61 are formed on the first and second surfaces 34A and 34B of the strip member 34 in the same layout as illustrated in FIGS. 10 to 12.

The coils 16 are, as clearly illustrated in FIG. 9, connected together using the patterned connecting conductors 40 each of which is arranged on one of axially opposed end portions of one of the strip members 34. Some of the patterned connecting conductors 40 which are arranged on the first surfaces 34A of the strip members 34 are denoted by solid lines. Some of the patterned connecting conductors 40 which are arranged on the second surface 34B of the strip members 34 are denoted by broken lines. Reference number “44” indicates a neutral point of the patterned connecting conductors 40. Reference number “43” indicate portions of the patterned connecting conductors 40 serving as connectors leading to a controller, not shown. The joints of the coils 16 and/or the conductors 40, 43, and 44 may be implemented by busbars or created using a printed circuit board.

The first strip member 34, as illustrated in FIGS. 4A, 9, 10, and 12, has the first end portion 34D and the second end portion 34C which are opposed to each other in the circumferential direction. The first and second end portions 34C and 34D overlap each other in the radial direction of the coil assembly 32. Specifically, the first end portion 34D of the first strip member 34 is arranged radially outside the second end portion 34C of the first strip member 34. The overlap between the first and second end portions 34D and 34C of the first strip member 34 creates a joint therebetween and will also be referred to below as the overlap 34E. A portion of the first strip member 34 other than the overlap 34E will also be referred to as the major portion 34F. In the first strip member 34 with the first and second end portions 34D and 34C being joined together, the coils U11T1, U11T2, U11T3, V11T3, V11T2, V11T1, W11T1, W11T2, and W11T3 overlap with the coils U21T1, U21T2, U21T3, V21T3, V21T2, V21T1, W21T1, W21T2, and W21T3 in the radial direction.

The second strip member 34, as illustrated in FIGS. 4A and 9, has the first end portion 34D and the second end portion 34C which are opposed to each other in the circumferential direction. The first and second end portions 34C and 34D overlap each other in the radial direction of the coil assembly 32. Specifically, the first end portion 34D of the second strip member 34 is arranged radially outside the second end portion 34C of the second strip member 34. The overlap between the first and second end portions 34D and 34C of the second strip member 34 creates a joint therebetween and will also be referred to below as the overlap 34E. In the second strip member 34 with the first and second end portions 34D and 34C being joined together, the coils U31T1, U31T2, U31T3, V31T3, V31T2, V31T1, W31T1, W31T2, and W31T3 overlap with the coils U41T1, U41T2, U41T3, V41T3, V41T2, V41T1, W41T1, W41T2, and W41T3 in the radial direction of the coil assembly 32. The second strip member 34, as can be seen in FIG. 4A, has an intermediate portion of a circumferential thereof which is shaped as the convex portion 34G to avoid a circumferential mechanical interference of the second strip member 34 with the first end portion 34D of the first strip member 34. The convex portion 34G bulges radially outward from a remaining portion of the second strip member 34. A portion of the second strip member 34 other than the overlap 34E and the convex portion 34G will also be referred to as the major portion 34F.

The third strip member 34, as illustrated in FIGS. 4A and 9, has the first end portion 34D and the second end portion 34C which are opposed to each other in the circumferential direction. The first and second end portions 34C and 34D overlap each other in the radial direction of the coil assembly 32. Specifically, the first end portion 34D of the third strip member 34 is arranged radially outside the second end portion 34C of the second strip member 34. The overlap between the first and second end portions 34D and 34C of the second strip member 34 creates a joint therebetween and will also be referred to below as the overlap 34E. In the third strip member 34 with the first and second end portions 34D and 34C being joined together, the coils U51T1, U51T2, U51T3, V51T3, V51T2, V51T1, W51T1, W51T2, and W51T3 overlap with the coils U61T1, U61T2, U61T3, V61T3, V61T2, V61T1, W61T1, W61T2, and W61T3 in the radial direction of the coil assembly 32. The third strip member 34, as illustrated in FIG. 4A, has two portions of a circumferential thereof which are shaped as the first and second convex portions 34G to avoid a circumferential mechanical interference of the third strip member 34 with the first end portion 34D and the convex portion 34G of the second strip member 34.

Each of the first and second convex portions 34G of the third strip member 34 bulges radially outward from a remaining portion of the third strip member 34. A portion of the second strip member 34 other than the overlap 34E and the first and second convex portions 34G will also be referred to as the major portion 34F.

The overlaps 34E of the first strip member 34 and the second strip member 34 are, as can be seen in FIGS. 4A and 9, located at an angular interval of 120° away from each other in the circumferential direction. Similarly, the overlaps 34E of the second strip member 34 and the third strip member 34 are located at an angular interval of 120° away from each other in the circumferential direction. Similarly, the overlaps 34E of the third strip member 34 and the first strip member 34 are located at an angular interval of 120° away from each other in the circumferential direction. In other words, the overlaps 34E of the first, second, and third strip members 34 are arranged at equal intervals away from each other in the circumferential direction of the coil assembly 32.

The overlap 34E of the first strip member 34, the convex portion 34G of the second strip member 34, and the convex portion 34G of the third strip member 34, as can be seen in FIG. 4A, overlap each other in the radial direction thereof to form the thick-walled portion 32A. The major portion 34F of the first strip member 34, the overlap 34E of the second strip member 34, and the convex portion 34G of the third strip member 34 overlap each other in the radial direction thereof to form the thick-walled portion 32A. Similarly, the major portion 34F of the first strip member 34, the major portion 34F of the second strip member 34, and the overlap 34E of the third strip member 34 overlap each other in the radial direction thereof to form the thick-walled portion 32A. In this embodiment, the three thick-walled portions 32A are arranged at equal intervals away from each other in the circumferential direction of the coil assembly 32. The major portion 34F of the first strip member 34, the major portion 34F of the second strip member 34, and the major portion 34F of the third strip member 34 overlap each other in the radial direction to form the thin-walled portion 32B. In this embodiment, the three thin-walled portion 32B are arranged at equal intervals away from each other in the circumferential direction of the coil assembly 32. The thick-walled portions 32A and the thin-walled portions 32B are located alternately in the circumferential direction. The thick-walled portions 32A have a thickness F1 greater than a thickness F2 of the thin-walled portions 32B in the radial direction of the coil assembly 32. The coil assembly 32 also has the shoulders 32C in the shape of steps which are formed at a boundary between each of the thin-walled portions 32B and a respective one of the thick-walled portions 32A and located close to the stator core 26. Each of the shoulders 32C extends radially outward from the thin-walled portion 32B toward the thick-walled portion 32A to have a height in the radial direction of the coil assembly 32. The above arrangements create a radially inner peripheral surface of the coil assembly 32 which is substantially flat or even. In the coil assembly 32 which is, as illustrated in FIG. 4B, installed radially inside the stator core 26, the thick-walled portions 32A are disposed to have radially outer surfaces placed in direct contact with or indirect contact with a radially inner surface of the stator core 26 through an insulator. The thin-walled portions 32B of the coil assembly 32 are disposed to have radially outer surfaces facing the radially inner surface of the stator core 26 through the clearances 33 therebetween. The first strip member 34, as clearly illustrated in FIG. 4A, has the electrical connectors 43 extending therefrom. The second strip member 34 also has the electrical connectors 43 extending therefrom. The third strip member 34 also has the electrical connectors 43 extending therefrom. The electrical connectors 43 are all located on the thin-walled portions 32B. The electrical connectors 43 of the first strip member 34, the electrical connectors 43 of the second strip member 34, and the electrical connectors 43 of the third strip member 34 are arranged at regular intervals of 120° away from each other in the circumferential direction.

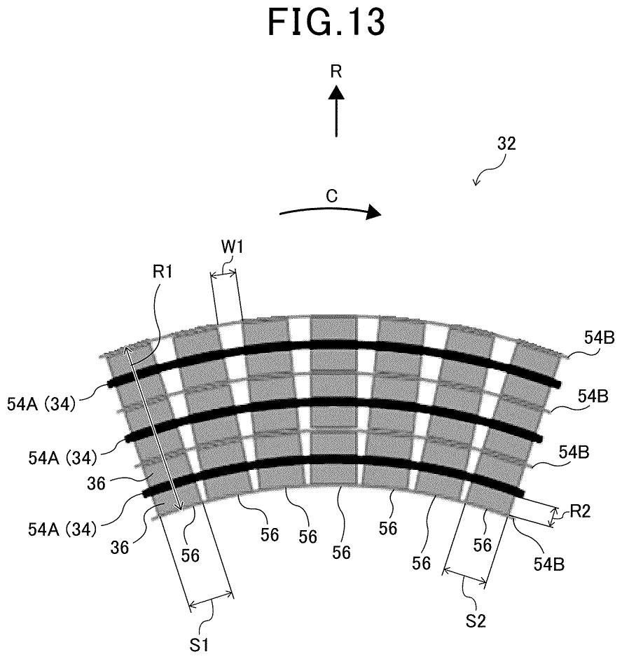

As apparent from the above discussion, the coil assembly 32 in this embodiment has the three strip members 34 rolled or wound to create turns laid or stacked on one another in the radial direction thereof to arrange the coils 16 at preselected locations both in the radial direction and in the circumferential direction of the coil assembly 32. FIG. 13 illustrates a portion of a cross-section of the coil assembly 32 made of a stack of the three strip members 34. The cross-section in FIG. 13 represents the vertical sections 36 of the coils 16 (see FIG. 7) and corresponds to one of the thin-walled portions 32B.

In the cross-section illustrated in FIG. 13, the vertical sections 36 of the coils 16 are stacked on one another in the radial direction of the coil assembly 32 and arranged at equal intervals away from each other in the circumferential direction of the coil assembly 32. The first insulating layer 54A or the second insulating layer 54B is disposed between a respective radially adjacent two of the vertical sections 36. Each of the first insulating layers 54A is implemented by a respective one of the strip members 34 and made from, for example, insulating paper or polyimide film.

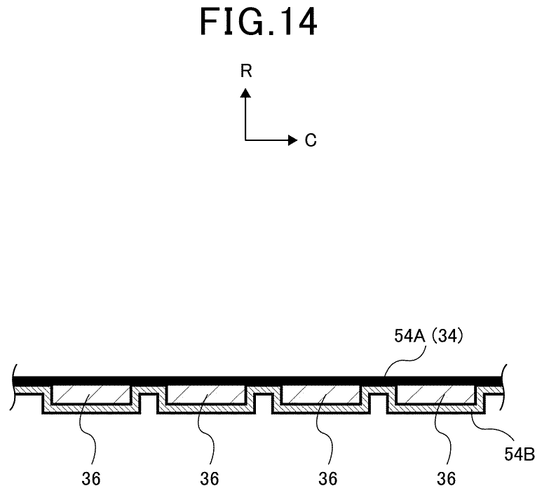

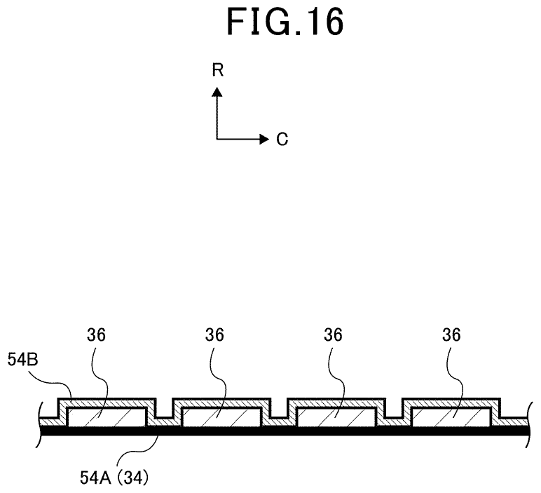

FIGS. 14 to 16 correspond to FIGS. 10 to 12 and illustrate cross-sections of the coil assembly 32 with the second insulating layer(s) 54B. The second insulating layers 54B are, as can be seen in the drawings, disposed on the strip members 34 in the form of insulating films and cover the coils 16. Each of the second insulating layers 54B may be made of an insulating coating material, such as polyimide material or varnish. Each of the strip members 34 may also have the second insulating layer 54B disposed on either of the first surface 34A or the second surface 34B which is, as can be seen in FIGS. 14 and 16, unoccupied by the coils 16. In the example illustrated in FIGS. 14 and 16, the first surface 34A or the second surface 34B of each of the strip members 34 which is unoccupied by the coils 16 has no second insulating layers 54B disposed thereon.

The vertical sections 36 of the coils 16 are, as clearly illustrated in FIG. 13, laid to overlap each other in the radial direction of the coil assembly 32. Stacks of the vertical sections 36 in the radial direction will also be referred to below as the vertical section stacks 56. When viewed radially in cross-section, each of the vertical section stacks 56 is of a rectangular shape which has a dimension R1 in the radial direction (i.e., thickness of the coil assembly 32) and a dimension S1 in the circumferential direction of the coil assembly 32 (i.e., thickness of the vertical section stacks 56 defined in the circumferential direction). The dimension R1 is greater than the dimension S1. Each of the vertical sections 46 of the vertical section stacks 56 has a dimension (i.e., width) S2 in the circumferential direction and a dimension (i.e., thickness) R2 in the radial direction of the coil assembly 32. The dimension S2 is greater than the dimension R2. An interval W1 between a respective adjacent two of the vertical sections 36 in the circumferential direction gradually increases from the radially inner periphery to the radially outer periphery of the coil assembly 32, thereby causing the vertical sections 36 of each of the vertical section stacks 56 are arranged in line, that is, aligned with each other in the radial direction. The vertical section stacks 56 are, therefore, located to extend in a radial way.

### Operation and Beneficial Effect in this Embodiment

An operation of this embodiment and beneficial advantages offered by this embodiment will be descried below.

In operation of the motor 10 in this embodiment, the energization of the U-phase coil group 42U, the V-phase coil group 42V, and the W-phase coil group 42W illustrated in FIGS. 1, 2, 5, and 9 are sequentially energized to create a rotating magnetic field inside the stator 14, thereby causing the rotor 12 to rotate. Arrows iU in FIG. 9 indicate directions in which electrical currents flow through the vertical sections 36 of the coils 16 at some point.

In this embodiment, the coil assembly 32, as described already, includes the three strip members 34 and the coils 16. Each of the strip members 34 is made of an electrically insulating material. The coils 16 are formed or disposed on the surfaces of the strip members 34. This structure enables the coil assembly 32 to be shaped to have a decreased size in the radial direction, thereby resulting in a decrease in total size of the motor 10.

The coil assembly 32 is, as clearly illustrated in FIG. 4A, designed to have the three thick-walled portions 32A which are arranged at equal intervals away from each other in the circumferential direction, thereby minimizing a risk that when the coil assembly 32 is installed radially inside the stator core 26, the coil assembly 32 may be undesirably shifted relative to the stator core 26. Specifically, as compared with when the thick-walled portions 32A are formed only in a single region of the coil assembly 32, the layout in which the thick-walled portions 32A are disposed at equal intervals away from each other minimizes misalignment of the coil assembly 32 with the stator core 26. One of the thick-walled portions 32A may be arranged to have at least a portion thereof which is arranged at an angular interval 180° away from at least a portion of another of the thick-walled portions 32A in the circumferential direction of the coil assembly 32 so that they face or are opposed to each other in the radial direction of the coil assembly 32. This minimizes the misalignment of the coil assembly 32 with the stator core 26 in the radial direction of the coil assembly 32. Alternatively, at least a portion of one of the thick-walled portions 32A may be located at an angular interval of 180° away from a region where at least two of the thick-walled portions 32A are arranged successively adjacent to each other in the circumferential direction of the coil assembly 32, thereby minimizing the misalignment of the coil assembly 32 with the stator core 26 in the radial direction of the coil assembly 32.

The coil assembly 32 in this embodiment is designed to have the shoulders 32C which are located at the boundary between each of the thin-walled portions 32B and a respective one of the thick-walled portions 32A and face the stator core 26. Each of the shoulders 32C extends radially outward from the thin-walled portion 32B toward the thick-walled portion 32A. In other words, the coil assembly 32 has no shoulders 32C on the inner periphery thereof which faces the magnets 18 of the rotor 12. This structure enables gaps between the inner periphery of the coil assembly 32 and the outer peripheries of the magnets 18 to be uniformed as compared with when the coil assembly 32 also has the shoulders 32C facing the magnets 18 of the rotor 12, thereby resulting in uniformity of the degree of torque produced by the motor 10.

Each of the vertical section stacks 56, as already described with reference to FIG. 13, has the dimension R1 in the radial direction which is greater than the dimension S1 thereof in the circumferential direction of the coil assembly 32. This enables the vertical section stacks 56 to be shaped to have decreased areas of the vertical section stacks 56 facing the magnets 18 of the rotor 12 without sacrificing required sectional areas thereof, which minimizes a risk that a radial magnetic flux may create an eddy current in the vertical section stacks 56. This enhances the degree of torque produced by the motor 10.

Each of the vertical sections 36 of the vertical section stacks 56 is shaped to have the dimension S2 in the circumferential direction which is greater than the dimension R2 thereof in the radial direction. This minimizes a risk that magnetic flux leaking into a gap between an adjacent two of the magnets 18 of the rotor 12 may create an eddy current in the vertical section stacks 56, thereby enhancing the degree of torque outputted by the motor 10. The thick-walled portion 32A, the thin-walled portion 32B, or the electrical connectors 43 are, as described above, arranged at equal intervals away from each other in the circumferential direction of the coil assembly 32, but however, may alternatively be disposed at irregular intervals away from each other. The interval W1 between a respective adjacent two of the vertical sections 36 in the circumferential direction is, as illustrated in FIG. 13, selected to increase from the inner periphery toward the outer periphery of the coil assembly 32, but however, the interval W1 may be kept substantially constant as long as the dimension S2 of each of the vertical sections 36 is selected to increase radially outward. In this geometry of the coil assembly 32, each of the vertical section stacks 56 is of a fan-shape, thereby enabling of the conductor of each of the coils 16 to have an increased sectional area, which enhances the degree of torque produced by the motor 10.

### Second Embodiment

An electrical motor according to the second embodiment will be described below. The same reference numbers as employed in the first embodiment will refer to the same or similar parts, and explanation thereof in detail will be omitted here.

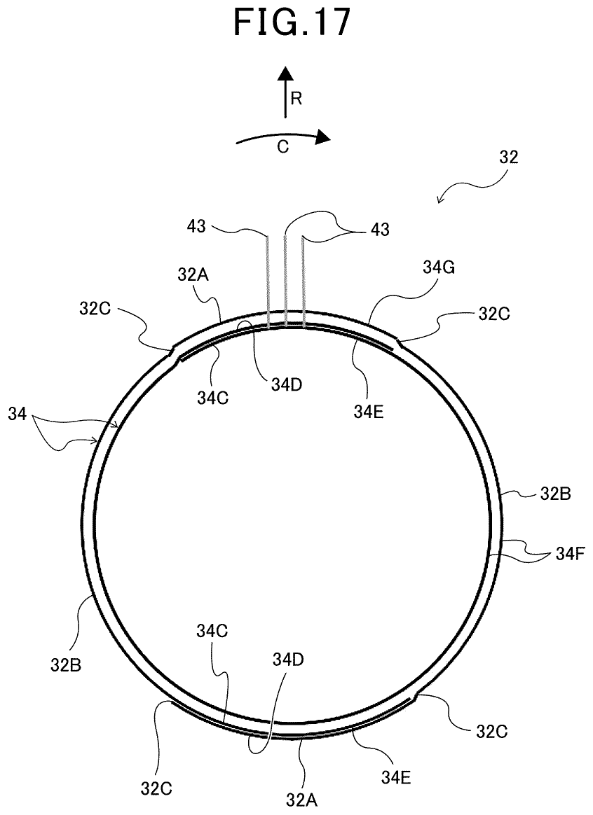

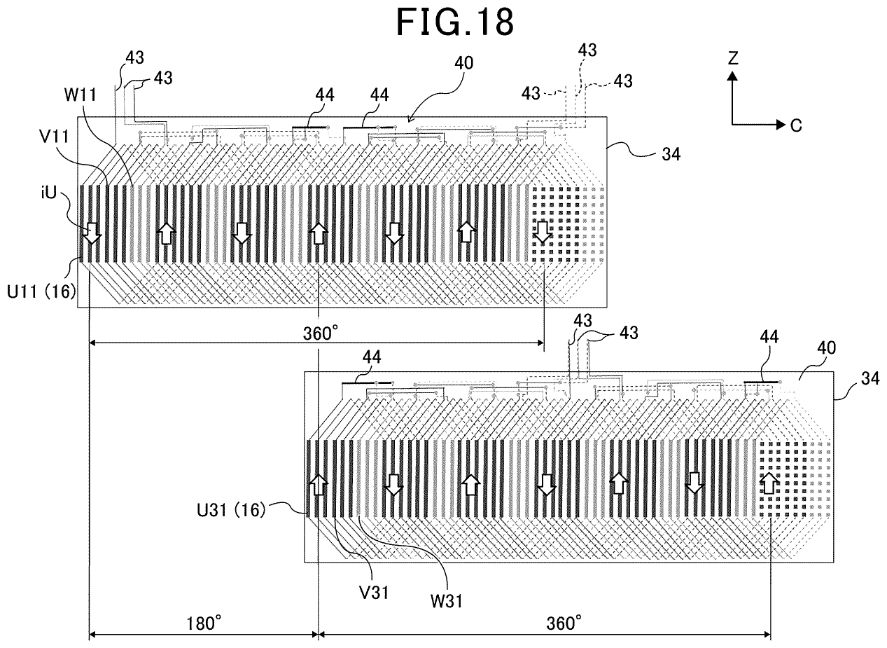

The motor in this embodiment is equipped with the coil assembly 32 illustrated in FIGS. 17 and 18. The coil assembly 32 includes the first strip member 34, the second strip member 34, and the coils 16 formed on the surfaces of the first and second strip members 34.

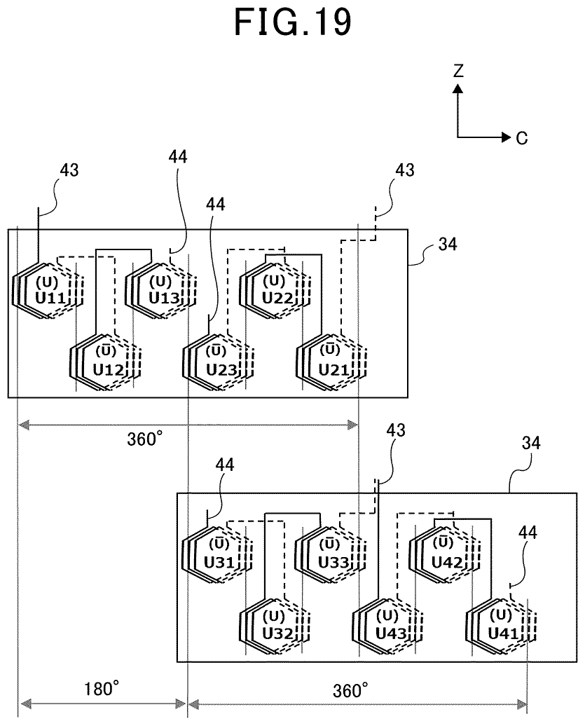

FIG. 19 corresponds to FIG. 8 and illustrates the U-phase coils 16 disposed on the first strip member 34 and the second strip member 34. An assembly of the coils U11, U12, U13, U23, U22, and U21 disposed on the first strip member 34 is different in locations of the electrical connector(s) 43 and the neutral point(s) 44 from those of the motor 10 in the first embodiment. The right-handed coil and the left-handed coil in this embodiment are in an inverse relation to those in the first embodiment. Other arrangements are identical, and explanation thereof in detail will be omitted here. The coils U31, U32, U33, U43, U42, and U41 formed on the second strip member 34 are identical in structure with those of the motor 10 in the first embodiment.

The V-phase coils V11 to V43 are arranged on the first strip member 34 and the second strip member 34 in the same layout as that of the coils U11 to U43. Similarly, the W-phase coils W11 to W43 are arranged on the first strip member 34 and the second strip member 34 in the same layout as that of the coils U11 to U43.

The overlap 34E of the first strip member 34 is, as clearly illustrated in FIG. 17, located at an angular interval of 180° away from the overlap 34E of the second strip member 34 in the circumferential direction of the coil assembly 32. In other words, the overlaps 34E of the strip members 34 are arranged at equal intervals away from each other in the circumferential direction.

The electrical connectors 43 extending from the first strip member 34 and the electrical connectors 43 extending from the second strip member 34 are, as can be seen in FIGS. 17 and 18, arranged to coincide with each other in the circumferential direction of the coil assembly 32. Specifically, a circumferential position of the U-phase electrical connector 42 extending from the first strip member 34 coincides with that of the U-phase connector 43 extending from the second strip member 34. Similarly, a circumferential position of the V-phase electrical connector 42 extending from the first strip member 34 are arranged to coincide with that of the V-phase connector 43 extending from the second strip member 34. Similarly, a circumferential position of the W-phase electrical connector 42 extending from the first strip member 34 coincides with that of the W-phase connector 43 extending from the second strip member 34. The electrical connectors 43 extending from the first and second strip members 34 are all located on one of the thick-walled portions 32A.

The coil assembly 32 of the motor in the second embodiment, as described above, has the two thick-walled portions 32A located at equal intervals away from each other in the circumferential direction. This layout minimizes a risk of radial misalignment of the coil assembly 32 with the stator core 26 when the coil assembly 32 is installed radially inside the stator core 26.

The coil assembly 32 in this embodiment is, as described above, designed to have the electrical connectors 43 extending from the first strip member 34 which are arranged in coincidence with those extending from the second strip member 34 in the circumferential direction of the coil assembly 32. This eliminates the need for additional parts used to connect the electrical connectors 43 of the same phase.

### Third Embodiment

An electrical motor according to the third embodiment will be described below. The same reference numbers as employed in the first embodiment to describe the motor 10 will refer to the same or similar parts, and explanation thereof in detail will be omitted here.

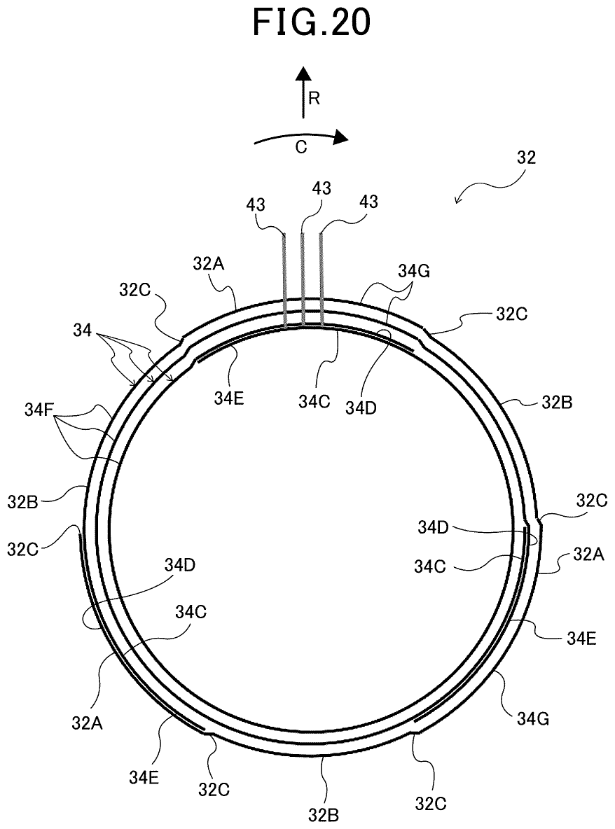

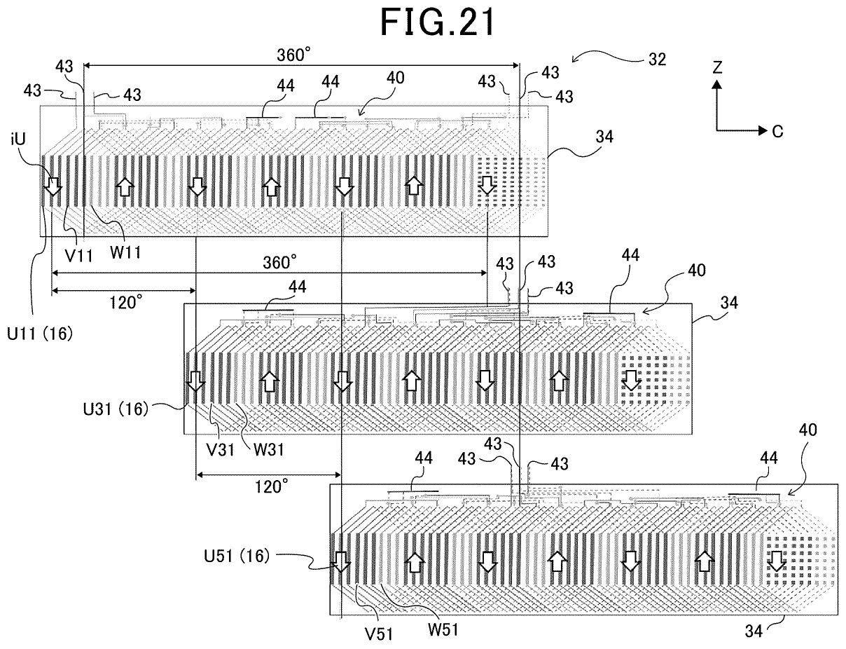

The coil assembly 32 of the motor in this embodiment, as illustrated in FIGS. 20 and 21, includes the first strip member 34, the second strip member 34, the third strip member 34, and the coils 16 formed on the first to third strip members 34.

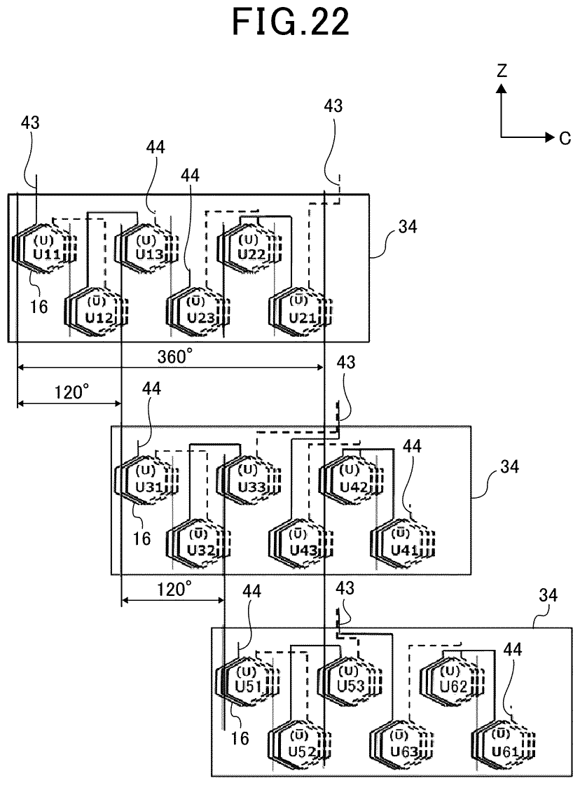

FIG. 22 corresponds to FIG. 8 and illustrates the U-phase coils 16 formed on the first strip member 34, the second strip member 34, and the third strip member 34. An assembly of the coils U11, U12, U13, U23, U22, and U21 disposed on the first strip member 34 is different in locations of the electrical connector(s) 43 and the neutral point(s) 44 from that of the motor 10 in the first embodiment. The coils U31, U32, U33, U43, U42, and U41 formed on the second strip member 34 are in an inverse relation of the right-handed coil and the left-handed coil to those in the first embodiment. Other arrangements are identical with those of the motor 10 in the first embodiment. An assembly of the coils U51, U52, U53, U63, U62, and U61 disposed on the third strip member 34 is identical in structure with that of the coils U31, U32, U33, U43, U42, and U41 formed on the second strip member 34 in this embodiment except that it is different in locations of the electrical connector(s) 43 and the neutral point(s) 44 from those of the coils U31, U32, U33, U43, U42, and U41 formed on the second strip member 34 in this embodiment.

The V-phase coils V11 to V63 are arranged on the first strip member 34, the second strip member 34, and the third strip member 34 in the same layout as that of the U-phase coils U11 to U63. Similarly, the W-phase coils W11 to W63 are arranged on the first strip member 34, the second strip member 34, and the third strip member 34 in the same layout as that of the U-phase coils U11 to U63.

The electrical connectors 43 extending from the first strip member 34, the electrical connectors 43 extending from the second strip member 34, and the electrical connectors 43 extending from the third strip member 34, as can be seen in FIGS. 20 and 21, coincide with each other in the circumferential direction of the coil assembly 32. The electrical connectors 43 extending from the first, second, and third strip members 34 are all located on one of the thick-walled portions 32A.

The coil assembly 32 of the motor in the third embodiment, as described above, has the three thick-walled portions 32A located at equal intervals away from each other in the circumferential direction thereof. This layout minimizes a risk of radial misalignment of the coil assembly 32 with the stator core 26 when the coil assembly 32 is installed radially inside the stator core 26.

The coil assembly 32 in this embodiment is, as described above, designed to have the electrical connectors 43 extending from the first strip member 34 which are arranged in coincidence with those extending from the second and third strip members 34 in the circumferential direction of the coil assembly 32, respectively. This eliminates the need for additional parts used to connect the electrical connectors 43 of the same phase.

### Fourth Embodiment

An electrical motor according to the fourth embodiment will be described below. The same reference numbers as employed in the first embodiment to describe the motor 10 will refer to the same or similar parts, and explanation thereof in detail will be omitted here.

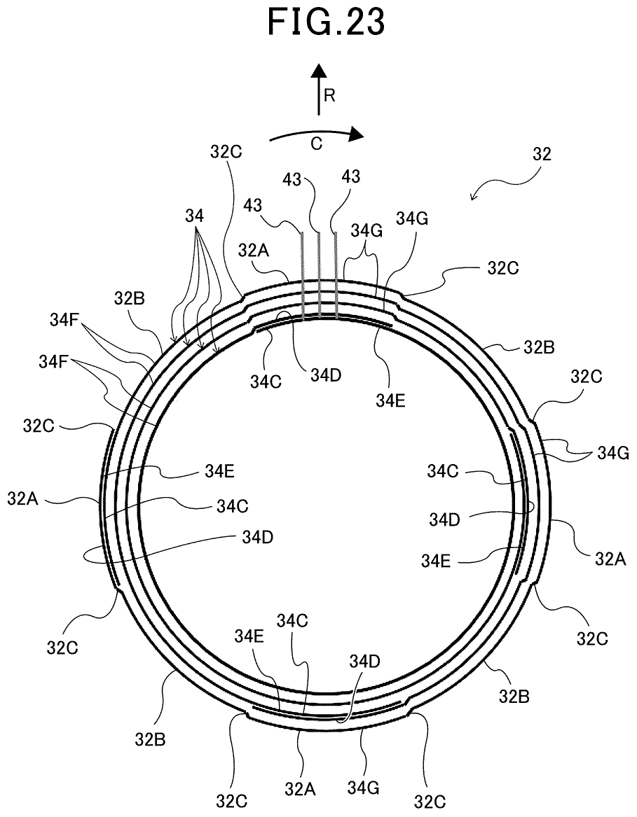

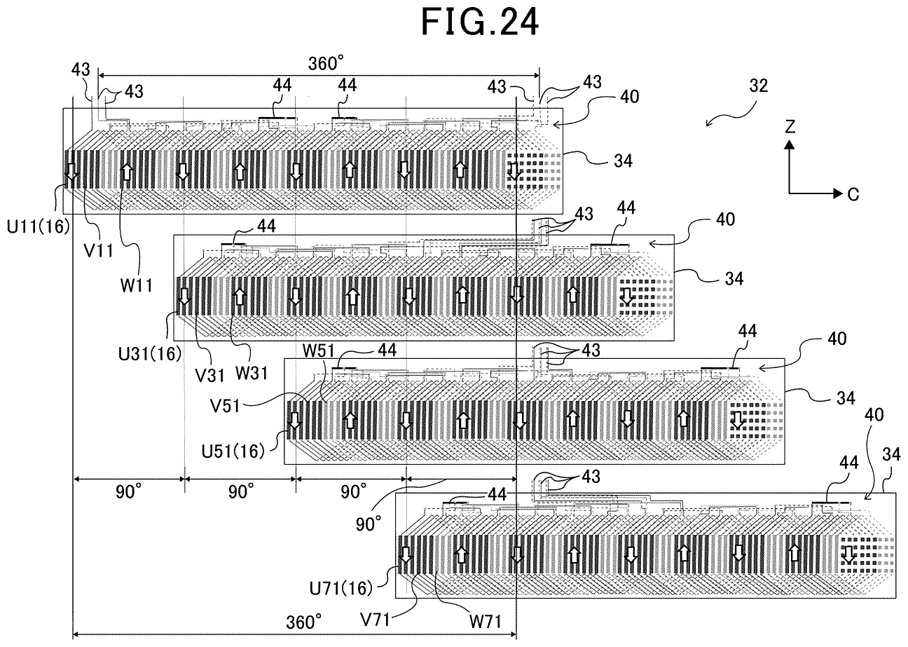

The coil assembly 32 of the motor in this embodiment, as illustrated in FIGS. 23 and 24, includes the first strip member 34, the second strip member 34, the third strip member 34, the fourth strip member 34, and the coils 16 formed on the first to fourth strip members 34.

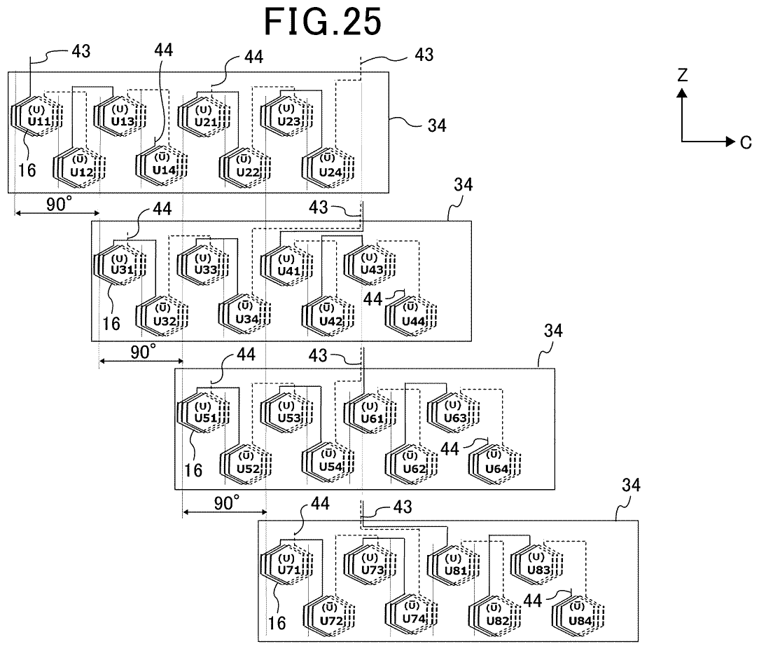

Specifically, the coil assembly 32, as can be seen in FIGS. 24 and 25, includes the 32 U-phase coils 16, the 32 V-phase coils 16, and the 32 V-phase coils 16 which are connected together in the form of a star-connection.

The U-phase coils 16 includes coils U11, U12, U13, U14, U21, U22, U23, U24, U31, U32, U33, U34, U41, U42, U43, U44, U51, U52, U53, U54, U61, U62, U63, U64, U71, U72, U73, U74, U81, U82, U83, and U84.

Similarly, the V-phase coils 16 includes coils V11, V12, V13, V14, V21, V22, V23, V24, V31, V32, V33, V34, V41, V42, V43, V44, V51, V52, V53, V54, V61, V62, V63, V64, V71, V72, V73, V74, V81, V82, V83, and V84.

Similarly, the W-phase coils 16 includes coils W11, W12, W13, W14, W21, W22, W23, W24, W31, W32, W33, W34, W41, W42, W43, W44, W51, W52, W53, W54, W61, W62, W63, W64, W71, W72, W73, W74, W81, W82, W83, and W84.

In the following discussion, a specified one(s) of the coils 16 will be denoted only using the above coil reference number(s).

The coils U11, U12, U13, and U14 are connected in series with each other. The coils U21, U22, U23, and U24 are connected in series with each other. The coils U31, U32, U33, and U34 are connected in series with each other. The coils U41, U42, U43, and U44 are connected in series with each other. The coils U51, U52, U53, and U54 are connected in series with each other. The coils U61, U62, U63, and U64 are connected in series with each other. The coils U71, U72, U73, and U74 are connected in series with each other. The coils U81, U82, U83, and U84 are connected in series with each other.

The coils U11 has a first end connecting with the coils U12 and a second end opposite the first end. The coil U24 has a first end connecting with the coils U23 and a second end opposite the first end. The coil U34 has a first end connecting with the coil U33 and a second end opposite the first end. The coil U41 has a first end connecting with the coil U42 and a second end opposite the first end. The coil U54 has a first end connecting with the coil U53 and a second end opposite the first end. The coil U61 has a first end connecting with the coil U62 and a second end opposite the first end. The coil U74 has a first end connecting with the coil U73 and a second end opposite the first end. The coil U81 has a first end connecting with the coil U82 and a second end opposite the first end. The second ends of the coils U11, U24, U34, U41, U54, U61, U74, and U81 are designed as the electrical connectors 43 which are connected together.

The V-phase coils V11 to V84 are connected together in the same way as the U-phase coils U11 to U84. The W-phase coils W11 to W84 are connected together in the same way as the U-phase coils U11 to U84.

The coil U14 has a first end connecting with the coil U13 and a second end opposite the first end. The coil V14 has a first end connecting with the coil V13 and a second end opposite the first end. The coil W14 has a first end connecting with the coil W13 and a second end opposite the first end. The second ends of the coils U14, V14, and W14 are connected together at the neutral point 44.

The coil U21 has a first end connecting with the coil U22 and a second end opposite the first end. The coil V21 has a first end connecting with the coil V22 and a second end opposite the first end. The coil W21 has a first end connecting with the coil W22 and a second end opposite the first end. The second ends of the coils U21, V21, and W21 are connected together at the neutral point 44.

The coil U31 has a first end connecting with the coil U32 and a second end opposite the first end. The coil V31 has a first end connecting with the coil V32 and a second end opposite the first end. The coil W31 has a first end connecting with the coil W32 and a second end opposite the first end. The second ends of the coils U31, V31, and W31 are connected together at the neutral point 44.

The coil U44 has a first end connecting with the coil U43 and a second end opposite the first end. The coil V44 has a first end connecting with the coil V43 and a second end opposite the first end. The coil W44 has a first end connecting with the coil W43 and a second end opposite the first end. The second ends of the coils U44, V44, and W44 are connected together at the neutral point 44.

The coil U51 has a first end connecting with the coil U52 and a second end opposite the first end. The coil V51 has a first end connecting with the coil V52 and a second end opposite the first end. The coil W51 has a first end connecting with the coil W52 and a second end opposite the first end. The second ends of the coils U51, V51, and W51 are connected together at the neutral point 44.

The coil U64 has a first end connecting with the coil U63 and a second end opposite the first end. The coil V64 has a first end connecting with the coil V63 and a second end opposite the first end. The coil W64 has a first end connecting with the coil W63 and a second end opposite the first end. The second ends of the coils U64, V64, and W64 are connected together at the neutral point 44.

The coil U71 has a first end connecting with the coil U72 and a second end opposite the first end. The coil V71 has a first end connecting with the coil V72 and a second end opposite the first end. The coil W71 has a first end connecting with the coil W72 and a second end opposite the first end. The second ends of the coils U71, V71, and W71 are connected together at the neutral point 44.

The coil U84 has a first end connecting with the coil U83 and a second end opposite the first end. The coil V84 has a first end connecting with the coil V83 and a second end opposite the first end. The coil W84 has a first end connecting with the coil W83 and a second end opposite the first end. The second ends of the coils U84, V84, and W84 are connected together at the neutral point 44.

The coils U11 to U24 are arranged on the first strip member 34 in this order. The coils U31 to U44 are arranged on the second strip member 34 in this order. The coils U51 to U64 are arranged on the third strip member 34 in this order. The coils U71 to U84 are arranged on the fourth strip member 34 in this order.

The V-phase coils V11 to V84 are, as can be seen in FIGS. 24 and 25, arranged on the first strip member 34, the second strip member 34, the third strip member 34, and the fourth strip member 34 in same layout as the U-phase coils U11 to U84. Similarly, the W-phase coils W11 to W84 are arranged on the first strip member 34, the second strip member 34, the third strip member 34, and the fourth strip member 34 in same layout as the U-phase coils U11 to U84.

In this embodiment, the four thick-walled portions 32A are, as clearly illustrated in FIG. 23, arranged at equal intervals away from each other in the circumferential direction of the coil assembly 32. Similarly, the four thin-walled portions 32B are arranged at equal intervals away from each other in the circumferential direction of the coil assembly 32. The thick-walled portions 32A and the thin-walled portions 32B are disposed alternately in the circumferential direction of the coil assembly 32.

The electrical connectors 43 extending from the first strip member 34, the electrical connectors 43 extending from the second strip member 34, the electrical connectors 43 extending from the third strip member 34, and the electrical connectors 43 extending from the fourth strip member 34, as can be seen in FIGS. 23 and 24, coincide with each other in the circumferential direction of the coil assembly 32, respectively. The electrical connectors 43 extending from the first, second, third, and fourth strip members 34 are all located on one of the thick-walled portions 32A.

The coil assembly 32 of the motor in the fourth embodiment, as described above, has the four thick-walled portions 32A located at equal intervals away from each other in the circumferential direction thereof. This layout minimizes a risk of radial misalignment of the coil assembly 32 with the stator core 26 when the coil assembly 32 is installed radially inside the stator core 26.

The coil assembly 32 in this embodiment is, as described above, designed to have the electrical connectors 43 extending from the first strip member 34 which are arranged in coincidence with those extending from the second, third strip, and fourth members 34 in the circumferential direction of the coil assembly 32, respectively. This eliminates the need for additional parts used to connect the electrical connectors 43 of the same phase.

### Fifth Embodiment

An electrical motor according to the fifth embodiment will be described below. The same reference numbers as employed in the first embodiment to describe the motor 10 will refer to the same or similar parts, and explanation thereof in detail will be omitted here.

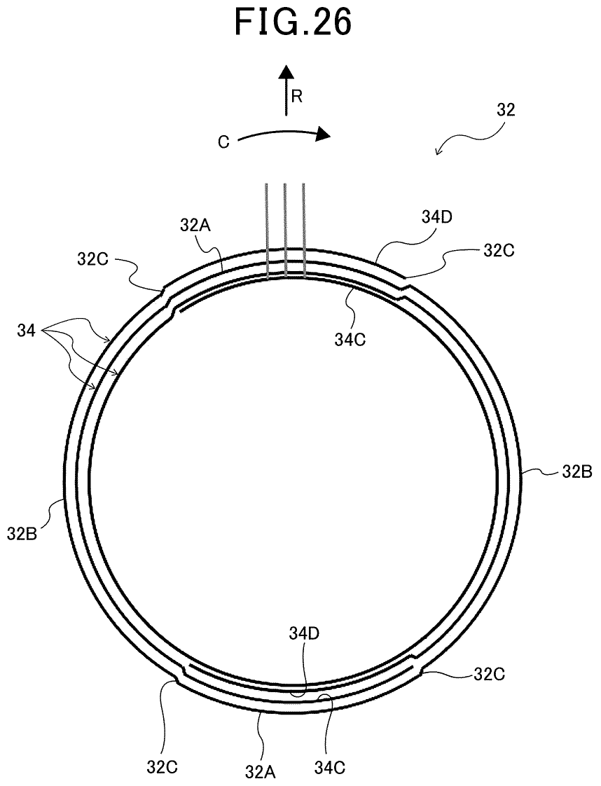

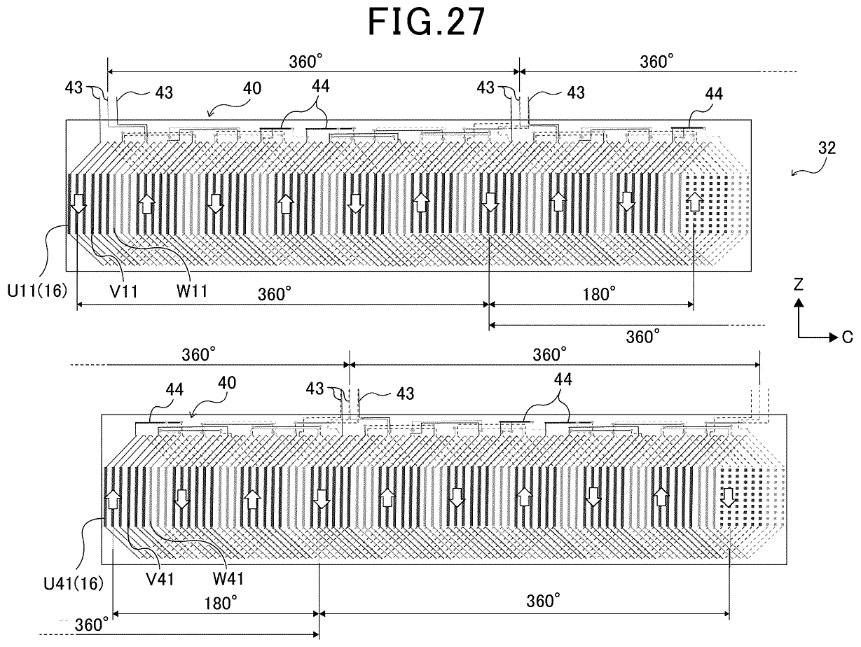

The coil assembly 32 of the motor in this embodiment, as illustrated in FIGS. 26 and 27, includes the 1.5 (i.e., one-and-a half) turn strip member 34 and a 1.5-to-3 turn strip member 34, and the coils 16 formed on the 1.5 turn strip member 34 and the 1.5-to-3 turn strip member 34.

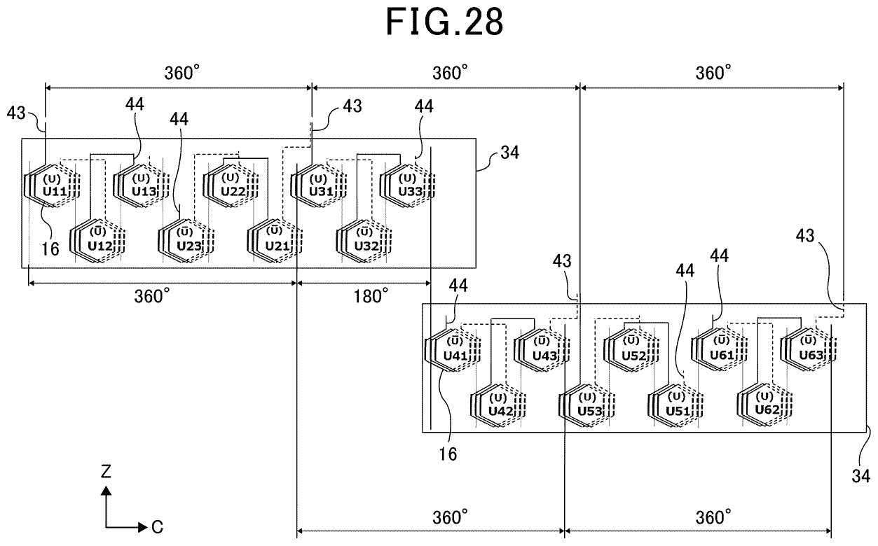

The coil assembly 32, as illustrated in FIGS. 27 and 28, includes 18 U-phase coils 16, 18 V-phase coils 16, and 18 W-phase coils 16 which are connected together in the form of a star-connection.

The coils U11, U12, and U13 are connected in series with each other. The coils U21, U22, and U23 are connected in series with each other. The coils U31, U32, and U33 are connected in series with each other. The coils U41, U42, and U43 are connected in series with each other. The coils U51, U52, and U53 are connected in series with each other. The coils U61, U62, and U63 are connected in series with each other.

The coils U11 has a first end connecting with the coils U12 and a second end opposite the first end. The coil U21 has a first end connecting with the coils U22 and a second end opposite the first end. The coil U31 has a first end connecting with the coil U32 and a second end opposite the first end. The coil U43 has a first end connecting with the coil U42 and a second end opposite the first end. The coil U53 has a first end connecting with the coil U52 and a second end opposite the first end. The coil U63 has a first end connecting with the coil U62 and a second end opposite the first end. The second ends of the coils U11, U21, U31, U43, U53, and U63 are designed as the electrical connectors 43 which are connected together.

The V-phase coils V11 to V63 are connected together in the same way as the U-phase coils U11 to U63. The W-phase coils W11 to W63 are connected together in the same way as the U-phase coils U11 to U63.

The coil U13 has a first end connecting with the coil U12 and a second end opposite the first end. The coil V13 has a first end connecting with the coil V12 and a second end opposite the first end. The coil W13 has a first end connecting with the coil W12 and a second end opposite the first end. The second ends of the coils U13, V13, and W13 are connected together at the neutral point 44.

The coil U23 has a first end connecting with the coil U22 and a second end opposite the first end. The coil V23 has a first end connecting with the coil V22 and a second end opposite the first end. The coil W23 has a first end connecting with the coil W22 and a second end opposite the first end. The second ends of the coils U23, V23, and W23 are connected together at the neutral point 44.

The coil U3 has a first end connecting with the coil U32 and a second end opposite the first end. The coil V33 has a first end connecting with the coil V32 and a second end opposite the first end. The coil W33 has a first end connecting with the coil W32 and a second end opposite the first end. The second ends of the coils U33, V33, and W33 are connected together at the neutral point 44.

The coil U41 has a first end connecting with the coil U42 and a second end opposite the first end. The coil V41 has a first end connecting with the coil V42 and a second end opposite the first end. The coil W41 has a first end connecting with the coil W42 and a second end opposite the first end. The second ends of the coils U41, V41, and W41 are connected together at the neutral point 44.

The coil U51 has a first end connecting with the coil U52 and a second end opposite the first end. The coil V51 has a first end connecting with the coil V52 and a second end opposite the first end. The coil W51 has a first end connecting with the coil W52 and a second end opposite the first end. The second ends of the coils U51, V51, and W51 are connected together at the neutral point 44.

The coil U61 has a first end connecting with the coil U62 and a second end opposite the first end. The coil V61 has a first end connecting with the coil V62 and a second end opposite the first end. The coil W61 has a first end connecting with the coil W62 and a second end opposite the first end. The second ends of the coils U61, V61, and W61 are connected together at the neutral point 44.

The U-phase coils U11, U12, U13, U23, U22, U21, U31, U32, and U33 are disposed on the 1.5 turn strip member 34 in this order. The U-phase coils U41, U42, U43, U53, U52, U51, U61, U62, and U63 are disposed on the 1.5-to-3 turn strip member 34 in this order.

The V-phase coils V11 to V63 are, as can be seen in FIGS. 27 and 28, disposed on the 1.5 turn strip member 34 and the 1.5-to-3 turn strip member 34 in the same layout as the U-phase coils U11 to U63. The W-phase coils W11 to W63 are disposed on the 1.5 turn strip member 34 and the 1.5-to-3 turn strip member 34 in the same layout as the U-phase coils U11 to U63.

The two thick-walled portions 32A are, as can be seen in FIG. 26, arranged at equal intervals away from each other in the circumferential direction of the coil assembly 32. Similarly, the two thin-walled portions 32B are arranged at equal intervals away from each other in the circumferential direction of the coil assembly 32. The thick-walled portions 32A and the thin-walled portions 32B are located alternately in the circumferential direction.

The electrical connectors 43 extending from the 1.5 turn strip member 34 and the electrical connectors 43 extending from the 1.5-to-3 turn strip member 34, as can be seen in FIGS. 26 and 27, coincide with each other in the circumferential direction of the coil assembly 32. The electrical connectors 43 extending from the 1.5 turn strip member 34 and the electrical connectors 43 extending from the 1.5-to-3 turn strip member 34 are all located on one of the thick-walled portions 32A.

The coil assembly 32 of the motor in the fifth embodiment, as described above, has the two thick-walled portions 32A located at equal intervals away from each other in the circumferential direction. This layout minimizes a risk of radial misalignment of the coil assembly 32 with the stator core 26 when the coil assembly 32 is installed radially inside the stator core 26.

The electrical connectors 43 extending from the 1.5 turn strip member 34 and the electrical connectors 43 extending from the 1.5-to-3 turn strip member 34 are, as described above, located in coincidence with each other in the circumferential direction of the coil assembly 32, respectively. This eliminates the need for additional parts used to connect the electrical connectors 43 of the same phase.

### Sixth Embodiment

An electrical motor according to the sixth embodiment will be described below. The same reference numbers as employed in the first embodiment to describe the motor 10 will refer to the same or similar parts, and explanation thereof in detail will be omitted here.

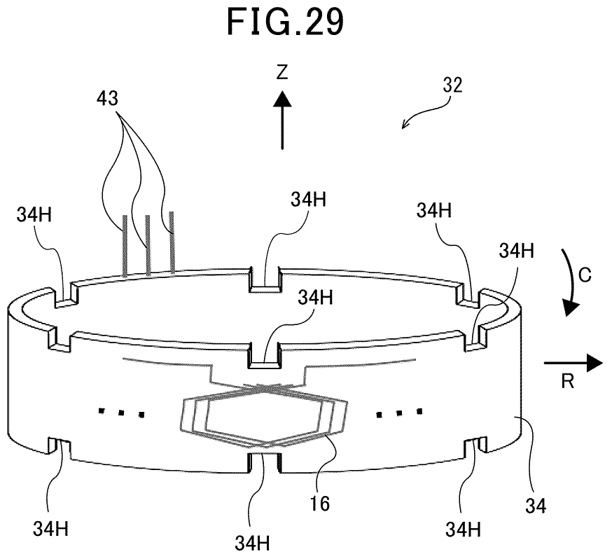

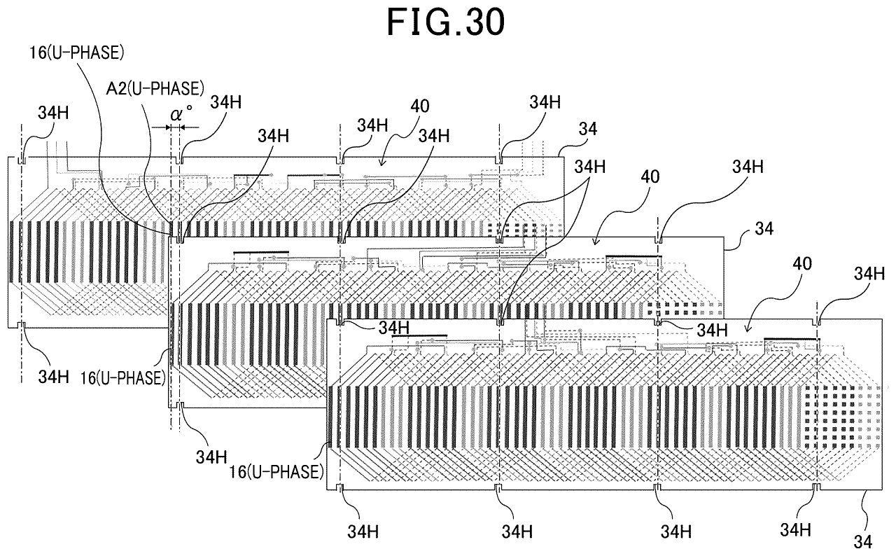

The coil assembly 32 in this embodiment, as illustrated in FIGS. 29 and 30, has a plurality of recesses 34H formed in a first circumferential end and a second circumferential end of each of the strip members 34 which are opposed to each other in the axial direction of the coil assembly 32. Each of the recesses 34H is of a rectangular shape as viewed in the radial direction of the coil assembly 32. In other words, each of the recesses 34H is of a U-shape with an opening facing in the first axial direction (i.e., upward direction as viewed in FIG. 29) or the second axial direction (i.e., downward direction as viewed in FIG. 29) opposite the first axial direction. Each of the recesses 34H is offset from an adjacent one of the second straight sections A2 of the U-phase coils 16 by an angle a° in the first circumferential direction.

The positioning of the second strip member 34 relative to the first strip member 34 or the positioning of the third strip member 34 relative to the second strip member 34 in the circumferential direction is achieved by engaging the stator core 26, a member secured to the stator core 26, or protrusions of a machining tool used to shape the strip members 34 into a hollow cylinder with the recesses 34H formed in the first strip member 34, the second strip member 34, and the third strip member 34. This also ensures the positioning of the coils 16 formed on the strip members 34 in the circumferential direction.

### Seventh and Eighth Embodiments

Electrical motors according to the seventh and eighth embodiments will be described below. The same reference numbers as employed in the first embodiment to describe the motor 10 will refer to the same or similar parts, and explanation thereof in detail will be omitted here.

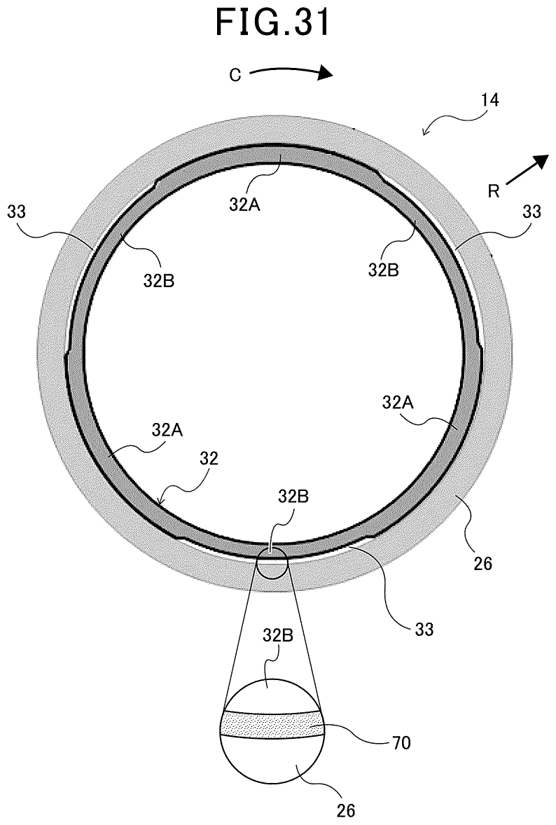

The motor in the seventh embodiment, as illustrated in FIG. 31, includes the stator 14 which has the adhesive 70 disposed in each of the clearances 33 defined between outer peripheral surfaces of the thin-walled portions 32B of the coil assembly 32 and an inner peripheral surface of the stator core 26. The adhesive 70 serves to achieve a firm joint between the stator core 26 and the coil assembly 32.

The above structure in the seventh embodiment enables the adhesive 70, as applied to the inner peripheral surface of the stator core 26 or the outer peripheral surface of the coil assembly 32, to be kept accumulated in the clearances 33 when the coil assembly 32 is inserted into the stator core 26, thereby ensuring the stability in mechanical joint between the stator core 26 and the coil assembly 32.

The coil assembly 32 in this embodiment may be designed, like the motor in the second embodiment (see FIG. 17), to have the electrical connectors 43 disposed in one of the thick-walled portions 32A, thereby minimizing a risk that at least a portion of the adhesive 70 leaking out of the clearances 33 may be attached to the electrical connectors 43.

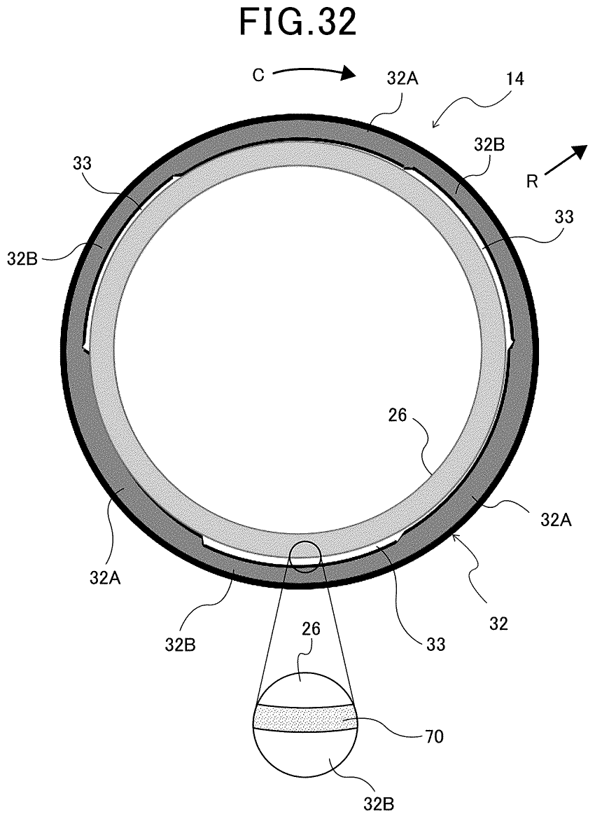

FIG. 32 illustrates the stator 14 installed in the motor according to the eighth embodiment. The motor in this embodiment is designed as an outer-rotor electrical motor in which the coil assembly 32 is disposed on an outer periphery of the stator core 26. The stator 14 has the adhesive 70 disposed in each of the clearances 33 defined between inner peripheral surfaces of the thin-walled portions 32B of the coil assembly 32 and an outer peripheral surface of the stator core 26. The adhesive 70 serves to achieve a firm joint between the stator core 26 and the coil assembly 32.

The motor in the eighth embodiment offers substantially the same beneficial advantages as those in the seventh embodiment.

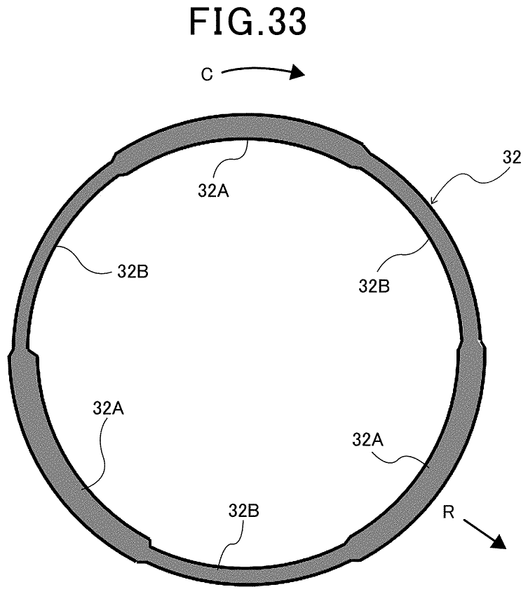

The coil assembly 32 may be, as illustrated in FIG. 33, designed to have the clearances 33 either when the coil assembly 32 is disposed on the outer peripheral surface of the stator core 26 or when the coil assembly 32 is disposed on the inner peripheral surface of the stator core 26. In other words, the coils assembly 32 may be designed for use either in outer-rotor motors or inner-rotor motors.

### Ninth Embodiment

An electrical motor according to the ninth embodiment will be described below. The same reference numbers as employed in the first embodiment to describe the motor 10 will refer to the same or similar parts, and explanation thereof in detail will be omitted here.

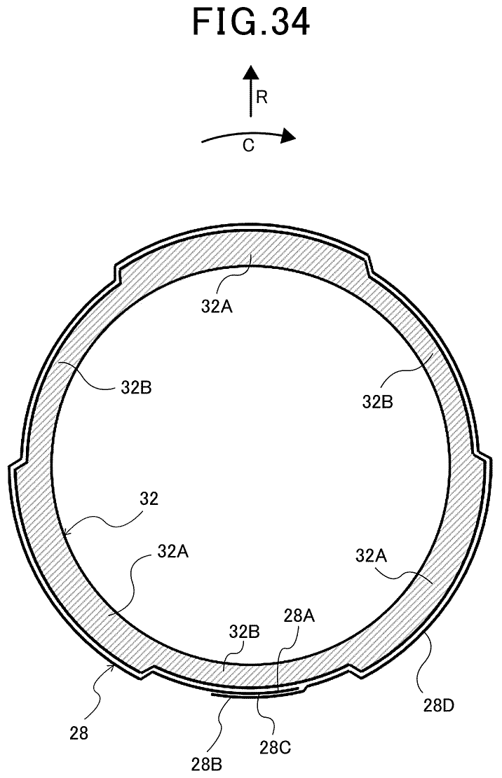

The motor in this embodiment, as illustrated in FIG. 34, includes the insulator 28 made from an electrically insulating material. The insulator 28 is arranged between the outer peripheral surface of the coil assembly 32 and the inner peripheral surface of the stator core 26 (see FIG. 4B).

The insulator 28 is of a rectangular shape having a width in the axial direction of the coil assembly 32 and a length extending in a direction perpendicular to the axial direction of the coil assembly 32. The insulator 28 has a thickness small enough to be curved in the length direction thereof (i.e., the circumferential direction of the coil assembly 32). For instance, the thickness of the insulator 28 is selected to be identical with or greater than those of the strip members 34. The thickness of the insulator 28 may alternatively be set smaller than those of the strip members 34. The insulator 28 is of a closed annular shape and wrapped about the outer periphery of the coil assembly 32. Specifically, the insulator 28 has the first end 28B facing in the first circumferential direction and the second end 28A facing in the second circumferential direction. The first and second ends 28B and 28A are laid to overlap each other in the radial direction of the coil assembly 34 to create the insulator-overlap portion 28C. A portion of the insulator 28 other than the insulator-overlap portion 28C will also be referred to below as an insulator-major portion 28D. The insulator-overlap portion 28C is located in one of the clearances 33 (see FIG. 4B) defined between the inner peripheral surface of the stator core 26 and the outer peripheral surfaces of the thin-walled portions 32B of the coil assembly 32.

The insulator-overlap portion 28C is, as described above, located in one of the clearances 33 defined between the stator core 26 and the thin-walled portions 32B of the coil assembly 32, thereby minimizing a risk that the insulator-overlap portion 28C may result in misalignment of the coil assembly 32 with the stator core 26 in the radial direction.

The total thickness F3 that is the sum of a thickness of the insulator-overlap portion 28C of the insulator 28 and a thickness of a corresponding one of the thin-walled portions 32B of the coil assembly 32 in the radial direction of the coil assembly 32 is preferably selected to be equal to a thickness F1 of each of the thick-walled portions 32A of the coil assembly 32 in the radial direction of the coil assembly 32. Layers of the adhesive 70 (see FIG. 31) may be arranged on circumferentially opposed sides of the insulator-overlap portion 28C of the insulator 28.

### Tenth and Eleventh Embodiments

Electrical motors according to the tenth and eleventh embodiments will be described below. The same reference numbers as employed in the first embodiment to describe the motor 10 will refer to the same or similar parts, and explanation thereof in detail will be omitted here.

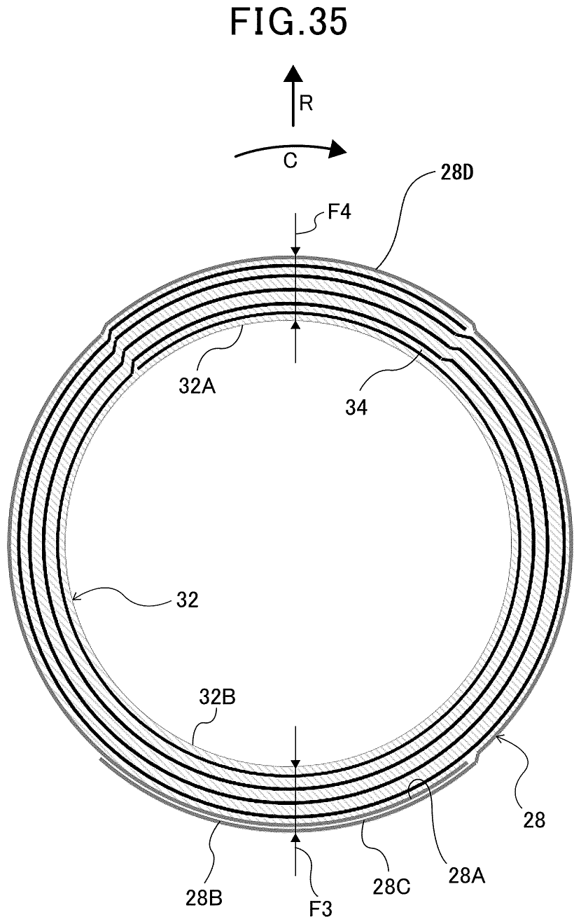

The coil assembly 32 of the motor in the tenth embodiment, as illustrated in FIG. 35, includes a single strip member 34 and a plurality of coils 16 (see FIG. 9) formed on the strip member 34. The strip member 34 is wound several times into the form of a plurality of turns. The insulator 28 is wrapped about the outer periphery of the coil assembly 32.

The thick-walled portion 32A of the coil assembly 32 and the insulator-overlap portion 28C of the insulator 28 are arranged at equal angular intervals away from each other in the circumferential direction of the coil assembly 32. The total thickness F3 that is the sum of a thickness of the insulator-overlap portion 28C of the insulator 28 and a thickness of the thin-walled portion 32B of the coil assembly 32 is selected to be equal to the thickness F4 that is the sum of a thickness of the insulator-major portion 28D of the insulator 28 and a thickness of the thick-walled portion 32A of the coil assembly 32.

In the structure in this embodiment, the thick-walled portion 32A of the coil assembly 32 and the insulator-overlap portion 28C of the insulator 28 are, as described above, arranged at equal angular intervals away from each other in the circumferential direction of the coil assembly 32. Additionally, the total thickness F3 that is the sum of a thickness of the insulator-overlap portion 28C of the insulator 28 and a thickness of the thin-walled portion 32B of the coil assembly 32 is, as described above, equal to the thickness F4 that is the sum of a thickness of the insulator-major portion 28D of the insulator 28 and a thickness of the thick-walled portion 32A of the coil assembly 32. In other words, the insulator-overlap portion 28C and the thin-walled portion 32B of the coil assembly 32 are laid to overlap each other in the radial direction, thereby minimizing the misalignment of the coil assembly 32 with the stator core 26 in the radial direction due to the thick-walled portion 32A.

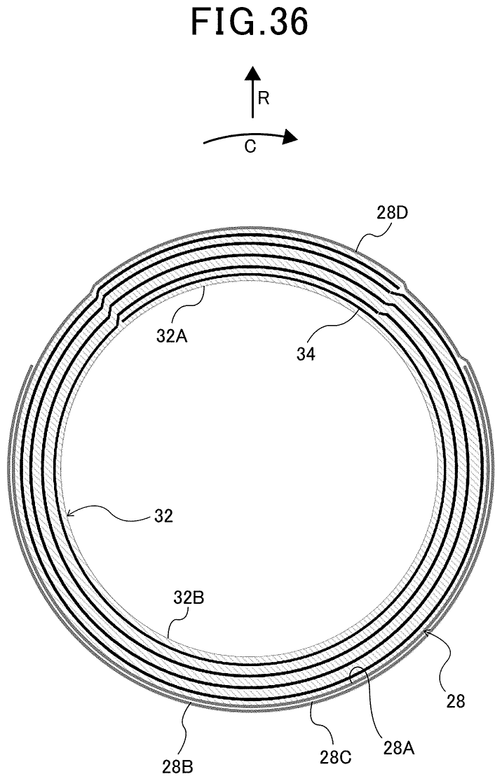

The insulator-overlap portion 28C may be, like in the coil assembly 32 of the motor in the eleventh embodiment illustrated in FIG. 36, elongated in the circumferential direction of the coil assembly 32. This enables the volume of the clearance(s) 33 filled with the adhesive 70 (see FIG. 31) to be altered or regulated using the insulator-overlap portion 28C.

### Twelfth Embodiment

An electrical motor according to the twelfth embodiment will be described below. The same reference numbers as employed in the first embodiment to describe the motor 10 will refer to the same or similar parts, and explanation thereof in detail will be omitted here.

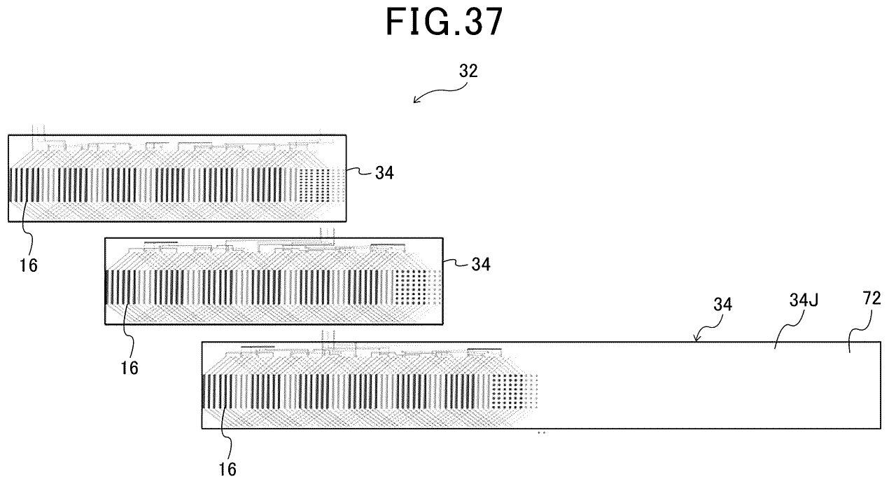

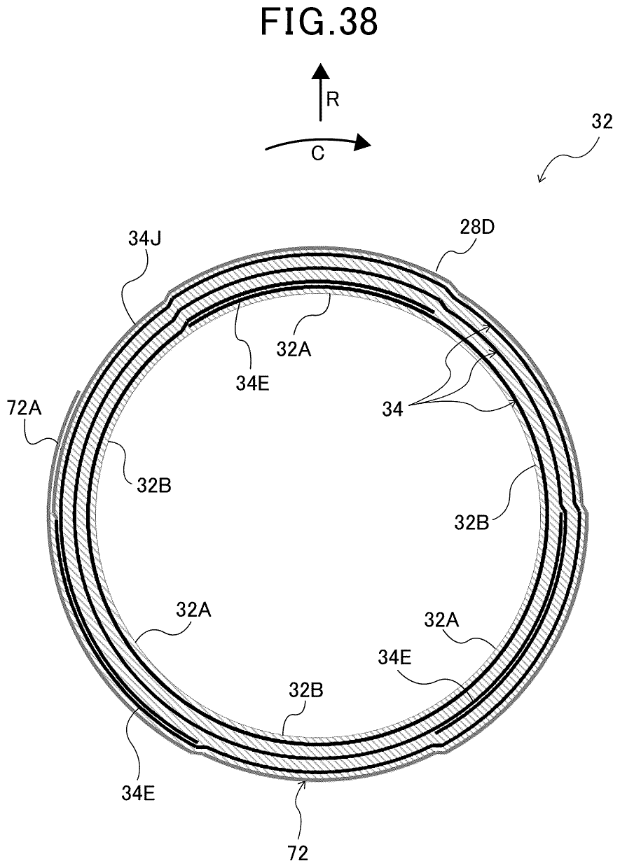

The coil assembly 32 of the motor in this embodiment, as illustrated in FIGS. 37 and 28, includes the coil-unoccupied portion 34J that is a portion of the length of the third strip member 34 which is located closer in the first circumferential direction. The third strip member 34 is, as illustrated in FIG. 4B, located closer to the stator core 26 than the first and second strip members 34 are. The coil-unoccupied portion 34J has no coil formed thereon. The coil-unoccupied portion 34J is curved into an annular form and extends in the circumferential direction. The coil-unoccupied portion 34J serves as the insulator 72. In other words, the insulator 72 forms a radially outer layer of the coil assembly 32.

The insulator 72 has portions overlapping each other in the radial direction of the coil assembly 32 to define the insulator-overlap portion 72A. The insulator-overlap portion 72A is arranged in one of the clearances 33 (see FIG. 4B) formed between the inner peripheral surface of the stator core 26 and the outer peripheral surfaces of the thin-walled portions 32B of the coil assembly 32.

The above-described motor in this embodiment has the coil-unoccupied portion 34J of one of the strip members 34 which plays a role in the same way as the insulator 28 of the motor in the tenth embodiment (see FIG. 35). This eliminates the need for making the insulator 28 using an additional discrete member, thereby minimizing the number of parts of the motor.

This disclosure is not limited to the above embodiment and the modifications, but may be realized by various embodiments without departing from the purpose of the disclosure. This disclosure includes all possible combinations of the features of the above embodiment and the modifications or features similar to the parts of the above embodiment and the modifications.

In each of the above embodiments, the coils 16 disposed on the strip members 34 are connected together in the form of a star-connection, but may be in the form of a delta-connection. The number of magnetic poles, phases, series-connected sets of the coils 16, or parallel-connected sets of the coils 16 of the motor in each of the above embodiments may be changed depending upon purpose. The motor in each of the embodiments may be used as an electrical generator or designed as an outer-rotor brush-less motor in which the rotor 12 is disposed radially outside the stator 14. The structure referred to in this disclosure may also be used with a rotor equipped with the coil assembly 32.

This disclosure is not limited to the above embodiments and the modifications, but may be realized by various embodiments without departing from the purpose of the disclosure. This disclosure includes all possible combinations of the features of the above embodiments and the modifications or features similar to the parts of the above embodiment and the modifications.

1. A coil assembly comprising:
a plurality of strip members which are made from an electrically insulating material, rolled in a circumferential direction of the coil assembly, and stacked on one another in a radial direction of the coil assembly, the strip members having at least portions overlapping each other in the radial direction of the coil assembly;
a plurality of coils which are made from an electrically conductive material and formed on the strip members, the coils being arranged in the circumferential direction;
a thin-walled portion which is defined by a portion of the strip members and has a first thickness in the radial direction; and
a plurality of thick-walled portions which are defined by portions of the strip members and have a second thickness in the radial direction which is greater than the first thickness, the thick-walled portions being arranged away from each other in the circumferential direction.

2. The coil assembly as set forth in claim 1, wherein the thick-walled portions are arranged away from each other both in a circumferential range of 0° to 180° and in a circumferential range of 180° to 360°,
a first one of the thick-walled portions has at least a portion located at an angular interval of 180° away from at least a portion of a second one of the thick-walled portions in the circumferential direction of the coil assembly, or
at least a portion of one of the thick-walled portions is located at an angular interval of 180° away from a region where at least two of the thick-walled portions are arranged successively adjacent to each other in the circumferential direction of the coil assembly.

3. The coil assembly as set forth in claim 1, wherein each of the strip members has a connector which extends therefrom and electrically connects with the coils, and
the connectors of the strip members are arranged to coincide with each other in the circumferential direction of the coil assembly.

4. The coil assembly as set forth in claim 1, wherein each of the strip members has a connector which extends therefrom and electrically connects with the coils, and
the connectors of the strip members are located away from each other in the circumferential direction of the coil assembly.

5. The coil assembly as set forth in claim 3, wherein the connectors extending from the strip members are located in one of the thick-walled portions.

6. The coil assembly as set forth in claim 3, wherein the connectors extending from the strip members are located in the thin-walled portion.

7. A coil assembly comprising:
a strip member which is made from an electrically insulating material and rolled in a circumferential direction of the coil assembly to have turns stacked in a radial direction of the coil assembly, the strip members having at least portions overlapping each other in the radial direction of the coil assembly;
coils which are made from an electrically conductive material and formed on the strip members, the coils being arranged in the circumferential direction;
a thin-walled portion which is defined by a portion of the strip members and has a first thickness in the radial direction; and
a plurality of thick-walled portions which are defined by portions of the strip members and have a second thickness in the radial direction which is greater than the first thickness, the thick-walled portions being arranged away from each other in the circumferential direction.

8. An armature comprising:
an armature core which is made from a soft magnetic material in a form of a hollow cylinder; and
a coil assembly set forth in claim 1, the coil assembly being arranged on one of a radial inner peripheral surface or a radial outer peripheral surface of the armature core.

9. The coil assembly as set forth in claim 8, further comprising an adhesive material is disposed in a clearance defined between the armature core and the thin-walled portion to achieve adhesion between the armature core and the coil assembly.

10. The coil assembly as set forth in claim 8, further comprising a shoulder which is formed at a boundary between the thin-walled portion and one of the thick-walled portions and located close to the armature core, the shoulder having a height in the radial direction of the coil assembly.

11. The coil assembly as set forth in claim 8, further comprising an annular insulator which is made from an electrically insulating material and has a length with a first end and a second end which are laid to overlap each other in the radial direction of the coil assembly,
the insulator is disposed between the armature core and the coil assembly to have the first and second ends arranged in a clearance formed between the armature core and the thin-walled portion of the coil assembly.

12. The coil assembly as set forth in claim 8, wherein one of the strip members which is located closest to the armature core has a coil-unoccupied portion where no coils are formed,
the coil-unoccupied portion is curved and extends in a circumferential direction of the coil assembly to serve as an insulator located close to the armature coil,
the insulator having portions which are laid to overlap each other in the radial direction of the coil assembly and arranged in a clearance formed between the armature core and the thin-walled portion of the coil assembly.

13. An armature comprising:
an armature core which is made from a soft magnetic material in a form of a hollow cylinder;
a coil assembly which is arranged on one of a radial inner peripheral surface and a radial outer peripheral surface of the armature core and includes a strip member, a plurality of coils, a thin-walled portion, and thick-walled portions, the strip member being made from an electrically insulating material and wound a plurality of times in a circumferential direction of the coil assembly, the coils being made from an electrically conductive material and arranged in a circumferential direction of the coil assembly, the thin-walled portion being defined by a portion of the strip member and having a first thickness in a radial direction of the coil assembly, the thick-walled portions being defined by portions of the strip member and having a second thickness in the radial direction which is greater than the first thickness, and
an annular insulator which is made from an electrically insulating material and has a length with a first end and a second end which are laid to overlap each other in the radial direction of the coil assembly, the insulator being disposed between the armature core and the coil assembly to have the first and second ends arranged in a clearance formed between the armature core and the thin-walled portion of the coil assembly.

14. A rotating electrical machine comprising:
a first one of a stator and a rotor which includes an armature set forth in claim 8; and
a second one of the stator and the rotor which includes magnets arranged to face a coil assembly in a radial direction of the coil assembly.
